(19) United States
(12) Patent Application Publication
(10) Pub. No.: US 2015/0160760 A1
(43) Pub. Date: Jun. 11, 2015

(54) TOUCH PANEL, METHOD FOR MANUFACTURING TOUCH PANEL, AND TOUCH PANEL INTEGRATED DISPLAY DEVICE

(71) Applicant: Wonder Future Corporation, Yokohama-shi, Kanagawa (JP)

(72) Inventor: Akira Sato, Hachiouji-shi (JP)

(73) Assignee: Wonder Future Corporation, Yokohama-shi, Kanagawa (JP)

(21) Appl. No.: 14/401,628

(22) PCT Filed: Aug. 20, 2013
(86) PCT No.: PCT/JP2013/072180

§ 371 Date: Nov. 17, 2014

(30) Foreign Application Priority Data
Sep. 13, 2012 (JP) 2012-201339

(51) Int. Cl. G06F 3/044; G06F 3/041; G06F 1/16

(52) U.S. Cl. CPC G06F 3/044; G06F 1/16; G06F 3/0412; G06F 1/1607; G06F 2203/04103; G06F 2203/04107; G06F 2203/04111; G06F 2203/04112

(57) ABSTRACT

An electrostatic capacitive touch panel includes a case body made of electric insulation transparent resin film, including a principal surface portion, side surface portions, and a hollow portion. The principal surface portion includes a principal surface input region, and at least one side surface portion includes a side surface input region. The principal surface portion includes first and second electrode rows. The side surface portion includes third and fourth electrode rows. One end of a first lead wiring is electrically connected to an end of the first or third electrode row. One end of a second lead wiring is electrically connected to an end of the second or fourth electrode row. Other ends of the first and second lead wiring are formed on the side surface portion not having the side surface input region. At least the first or second lead wiring passes through the side surface portions boundary.

### TECHNICAL FIELD

The present invention relates to a touch panel.

### BACKGROUND ART

A touch panel is used as an input device. The input device is a device for operating various types of electronic equipment. The touch panel is mounted to, for example, a display surface side of a liquid crystal display device. Input operation is performed according to display contents of the display device visually recognized through the touch panel. For example, an input tool (e.g., touch pen) or a human finger designates (touches or approaches) an arbitrary position on a touch surface. This enables the input operation. Known examples of such touch panel include a resistive membrane system type touch panel and an electrostatic capacity coupling type touch panel.

The electrostatic capacity coupling type touch panel is provided with a sensing electrode for sensing a touched position in a two-dimensional (x, y) direction of an image displaying region (input region by touch or approach). The sensing electrode is made of, for example, a crystalline (or amorphous) ITO (Indium Tin Oxide) or IZO (Indium Zinc Oxide). Alternatively, the sensing electrode is made of an electroconductive thin wiring. The electrode is provided on both of surfaces (or one of the surfaces) of a base material that is made of clear glass (or a transparent resin film). A lead-out circuit pattern that is connected to the sensing electrode is formed on a video nondisplay area (a region outside a display area (frame region)). The lead-out circuit pattern is formed on a surface on which the sensing electrode is formed.

Many reports are found as to the touch panel. For example, the below listed prior art documents include such reports.

Patent literature 1 discloses the following touch panel.

“A narrow frame touch panel formed into a three-dimensional shape having a front surface and side surfaces:

wherein the front surface of the touch panel is provided with a touched position sensing surface for sensing a touched position;

wherein the side surfaces of the touch panel are provided with electrodes and a read circuit for connecting the electrodes to an output part to the outside; and

wherein the front surface of the touch panel is arranged on a surface of a LCD, and the side surfaces of the touch panel are arranged on side portions of the LCD.”

Patent literature 2 discloses the following conductive sheet.

“A conductive sheet including:

a transparent substrate;

a first conductive part formed on one principal surface of the transparent substrate, the first conductive part having more than one first fine-wiring conductive patterns each extending in a first direction and arranged in a second direction perpendicular to the first direction; and

a second conductive part contacting the other principal surface of the transparent substrate, the second conductive part having more than one second fine-wiring conductive patterns each extending in a third direction and arranged in a fourth direction perpendicular to the third direction;

wherein the first fine-wiring conductive pattern includes a conductive fine-wiring portion and first electrostatic capacitive sensing units formed on the fine wiring at predetermined intervals;

wherein the second fine-wiring conductive pattern includes a conductive fine-wiring portion and second electrostatic capacitive sensing units formed on the fine-wiring at predetermined intervals; and

wherein the first fine-wiring conductive pattern and the second fine-wiring conductive pattern are arranged so as to cross to each other when viewed through the conductive sheet, the first and the second fine-wiring conductive patterns being formed into approximately a linear shape, and a line width a of the fine-wiring portion being within a range between 0.1 and 25 μm; and

wherein the first and the second electrostatic capacitive sensing units include openings.”

Patent literature 2 further discloses a “method for manufacturing the conductive sheet”.

Patent literature 3 discloses “a cellular phone including an input portion provided on a side surface (side surface input portion)” and “wherein the side surface input portion includes a flexible printed wiring board and a plurality of sensing electrodes, and the flexible printed wiring board is provided with a plurality of touch sensor sensing electrodes in order to mount the side surface input portion”.

Non-patent literature 1 discloses “material and technology trends of the touch panel market”.

### CITATION LIST

### Patent Literature

### [Patent Literature 1]

Japanese Unexamined Patent Application, First Publication No. 2010-146418

### [Patent Literature 2]

Japanese Unexamined Patent Application, First Publication No. 2012-53644

### [Patent Literature 3]

Japanese Unexamined Patent Application, First Publication No. 2011-44933

### [Patent Literature 4]

Japanese Unexamined Patent Application, First Publication No. 2007-72902

### [Patent Literature 5]

Japanese Unexamined Patent Application, First Publication No. 2012-88683

### [Patent Literature 6]

Japanese Unexamined Patent Application, First Publication No. 2011-3169

### [Patent Literature 7]

Japanese Unexamined Patent Application, First Publication No. 2012-174190

### [Patent Literature 8]

Japanese Unexamined Patent Application, First Publication No. 2012-146297

### [Patent Literature 9]

Japanese Unexamined Patent Application, First Publication No. 2012-141690

### [Patent Literature 10]

Japanese Unexamined Patent Application, First Publication No. 2011-175335

### [Patent Literature 11]

Japanese Unexamined Patent Application, First Publication No. 2011-154561

### [Patent Literature 12]

Japanese Unexamined Patent Application, First Publication No. 2010-262557

### Non-Patent Literature

### [Non Patent Literature 1]

Journal of Electric Glass Industry Association, “Material and Technology Trends of the Touch Panel Market”, Kenji Nakatani, Electric Glass, No. 45, (April 2011) pp. 7-13

### SUMMARY OF INVENTION

### Technical Problem

In the conventional touch panel, lead wirings are formed on an outside region (a non-active region; a non-display area in a display device; outside a touch input region of a touch panel; a design region where a light impermeable design printed layer is formed; a decoration region; a frame region; a window frame region) of a principal surface occupying the maximum area of the touch panel (an active area; a display area of a display device; a touch input region of the touch panel). The area of the non-active region (frame region) is not small. The side surface portion of the touch panel is not used as the touch input region.

In the conventional touch panel, a plurality of transparent electrodes for detecting a touched position (input) is formed on a surface having the maximum area (a principal surface of the touch panel). A lead-out circuit pattern is formed on the principal surface. The lead-out circuit pattern is formed on a surface where the pattern of the transparent electrodes is formed. A frame region on which the lead-out circuit pattern is formed is not a display area. The display area (touch input region) is limited to a region excluding the frame region of the touch panel principal surface. Therefore, there is a limit to enlarge a ratio of the display area (input region) to the touch panel principal surface. In a case where a large display surface is required, it is necessary to enlarge the area of the touch panel principal surface. Since the input region was formed only on the touch panel principal surface, there was a limit on an operability of the touch panel.

In a transparent conductive film made of, for example, the ITO (IZO), increase of light transmittance and lowering of resistance are mutually opposing features. It is hard to achieve both of the increase of light transmittance and the lowering of resistance. The transparent conductive film made of, for example, ITO (IZO) is hard, readily deformable, and readily crackable. The transparent conductive film lacks flexibility. More specifically, in a case where the transparent conductive film made of ITO (IZO) is used, even with the transparent resin film is used as a base material, the resulting product will have less flexibility.

Conventionally, there was no concept of forming the sensing electrode of the touch panel of an electroconductive thin wiring (specifically, of a leading wiring with a net-shaped pattern). In other words, improvement of flexibility and enhancement of light permeability were not studied based on the above described concept. Therefore, there were no such concepts that a ratio of display area (input region) to a single surface (principal surface) of the touch panel was to be enlarged as well as the touch panel was to be provided with the input region also on side surfaces crossing the principal surface. In sum, there was no concept of a touch panel with input regions on a plurality of surfaces of the touch panel.

The present invention was made to solve the above described problem. An object of the present invention is to provide a touch panel having an input region on a principal surface and side surfaces of the touch panel.

### Solution to Problem

The present invention is directed to an electrostatic capacitive touch panel including:

a case body made of an electrically insulating transparent resin film;

wherein the case body includes a principal surface portion, side surface portions, and a hollow portion;

wherein the hollow portion is a region defined by the principal surface portion and the side surface portions;

wherein the side surface portions are
continuous to the principal surface portion, and
approximately orthogonal to the principal surface portion;

wherein there are at least four side surface portions approximately orthogonal to the principal surface portion;

wherein at least two side surface portions of the side surface portions are approximately orthogonal to a first direction in the principal surface portion;

wherein at least another two side surface portions of the side surface portions are approximately orthogonal to a second direction in the principal surface portion;

wherein the principal surface portion includes a principal surface input region;

wherein at least one side surface portion of the at least four side surface portions includes a side surface input region;

wherein the principal surface portion is provided with at least two first electrode rows and at least two second electrode rows;

wherein the at least two first electrode rows are arranged
at predetermined distances, and
in the first direction;

wherein the at least two second electrode rows are arranged
at predetermined distances, and
in the second direction;

wherein each of the first electrode rows and each of the second electrode rows include at least two island-shaped electrodes and inter-electrode wirings electrically connecting the island-shaped electrodes;

wherein the at least one side surface portion including the side surface input region is provided with one or more third electrode rows and one or more fourth electrode rows;

wherein the third electrode rows are arranged on an extension of the first electrode rows (and/or the second electrode rows);

wherein the fourth electrode rows are arranged in a direction of the second electrode rows (and/or the first electrode rows);

wherein ends of the first electrode rows or ends of the third electrode rows are electrically connected to one ends of first lead wirings;

wherein the other ends of the first lead wirings are formed on the side surface portion without including the side surface input region;

wherein ends of the second electrode rows and ends of the fourth electrode rows are electrically connected to one ends of second lead wirings;

wherein the other ends of the second lead wirings are formed on the side surface portion without including the side surface input region; and

wherein at least one of the first lead wirings and the second lead wirings pass through a ridgeline portion as a boundary between the neighboring side surface portions.

The present invention proposes the electrostatic capacitive touch panel, wherein the first electrode rows are provided on one surface side of the principal surface portion, wherein the second electrode rows are provided on the other surface side of the principal surface portion, wherein the third electrode rows are provided on a surface side where the electrode rows as origins of the third electrode rows are provided, and wherein the fourth electrode rows are provided on a surface side where the electrode rows along with the fourth electrode rows are provided.

The present invention proposes the electrostatic capacitive touch panel, wherein the first electrode rows and the second electrode rows are provided on one surface side of the principal surface portion, wherein electrically insulative spacers are provided between the first electrode rows and the second electrode rows at crossings between the first electrode rows and the second electrode rows, wherein the third electrode rows and the fourth electrode rows are provided on one surface side of the side surface portion, and wherein electrically insulative spacers are provided between the third electrode rows and the fourth electrode rows at crossings between the third electrode rows and the fourth electrode rows.

The present invention proposes the electrostatic capacitive touch panel, wherein the lead wirings passing through the ridgeline portion are arranged on an inner surface side of the case body.

The present invention proposes the electrostatic capacitive touch panel, wherein center positions of the island-shaped electrodes of the first electrode rows and center positions of the island-shaped electrodes of the second electrode rows are arranged so as to be differently positioned from one another when viewed from a direction orthogonal to the principal surface portion.

The present invention proposes the electrostatic capacitive touch panel, wherein the island-shaped electrodes of the first electrode rows and the island-shaped electrodes of the second electrode rows do not substantially overlap to one another when viewed from a direction orthogonal to the principal surface portion.

The present invention proposes the electrostatic capacitive touch panel, wherein a visible light shielding layer is provided on a region outside the principal surface input region of the principal surface portion and/or on a region outside the side surface input region of the side surface portion.

The present invention proposes the electrostatic capacitive touch panel, wherein a transparent resin layer is provided on a front surface of the case body.

The present invention proposes the electrostatic capacitive touch panel, wherein a hard coat layer is provided on the front surface of the case body.

The present invention proposes the electrostatic capacitive touch panel, wherein the transparent resin layer is provided on the front surface of the case body, and wherein the hard coat layer is provided on a front surface of the transparent resin layer.

The present invention proposes the electrostatic capacitive touch panel, wherein a reinforcing frame is provided inside the side surface portions of the case body.

The present invention proposes the electrostatic capacitive touch panel, wherein the island-shaped electrodes in the principal surface input region are made of net-shaped conductors.

The present invention proposes the electrostatic capacitive touch panel, wherein the electrode rows in the principal surface input region are made of net-shaped conductors.

The present invention proposes the electrostatic capacitive touch panel, wherein the electrode rows in the principal surface input region and the side surface input region are made of net-shaped conductors.

The present invention proposes the electrostatic capacitive touch panel, wherein the conductor is made of at least one metal selected from the group consisting of Ag, Au, Cu, and Al.

The present invention proposes the electrostatic capacitive touch panel, wherein external connection terminals are formed on the side surface portion without including the side surface input region, wherein one of other ends of the first lead wirings and other ends of the second lead wirings are connected to the external connection terminals via throughholes, and wherein the other one of the other ends of the first lead wirings and the other ends of the second lead wirings are connected to the external connection terminals without passing through the throughholes.

The present invention proposes the electrostatic capacitive touch panel, wherein front surfaces of the external connection terminals are covered with carbon.

The present invention proposes a method for manufacturing an electrostatic capacitive touch panel, the electrostatic capacitive touch panel including

a case body made of an electrically insulating transparent resin film;

wherein the case body includes a principal surface portion, side surface portions, and a hollow portion;

wherein the hollow portion is a region defined by the principal surface portion and the side surface portions;

wherein the side surface portions are
continuous to the principal surface portion, and
approximately orthogonal to the principal surface portion;

wherein there are at least four side surface portions approximately orthogonal to the principal surface portion;

wherein at least two side surface portions of the side surface portions are approximately orthogonal to a first direction in the principal surface portion;

wherein at least another two side surface portions of the side surface portions are approximately orthogonal to a second direction in the principal surface portion;

wherein the principal surface portion includes a principal surface input region;

wherein at least one side surface portion of the at least four side surface portions includes a side surface input region;

wherein the principal surface portion is provided with at least two first electrode rows and at least two second electrode rows;

wherein the at least two first electrode rows are arranged
at predetermined distances, and
in the first direction;

wherein the at least two second electrode rows are arranged
at predetermined distances, and
in the second direction;

wherein each of the first electrode rows and each of the second electrode rows include at least two island-shaped electrodes and inter-electrode wirings electrically connecting the island-shaped electrodes;

wherein the side surface portion including the side surface input region is provided with one or more third electrode rows and one or more fourth electrode rows;

wherein the third electrode rows are arranged on an extension of the first electrode rows (and/or the second electrode rows);

wherein the fourth electrode rows are provided in a direction of the second electrode rows (and/or the first electrode rows);

wherein ends of the first electrode rows or ends of the third electrode rows are electrically connected to one ends of first lead wirings;

wherein the other ends of the first lead wirings are formed on a side surface portion without including the side surface input region;

wherein ends of the second electrode rows and ends of the fourth electrode rows are electrically connected to one ends of second lead wirings;

wherein the other ends of the second lead wirings are formed on the side surface portion without including the side surface input region; and

wherein at least one of the first lead wirings and the second lead wirings pass through a ridgeline portion as a boundary between the neighboring side surface portions, the method for manufacturing the electrostatic capacitive touch panel including:

forming conductor patterns on the electrically insulating transparent resin film, the conductor patterns constituting the first electrode rows, the second electrode rows, the third electrode rows, the fourth electrode rows, the first lead wirings, and the second lead wirings; and

molding, after forming the conductor patterns, the electrically insulating transparent resin film into the case body.

The present invention proposes the method for manufacturing the electrostatic capacitive touch panel including:

a process of forming conductor patterns to be formed on the electrically insulating transparent resin film, the conductor patterns constituting the first electrode rows, the second electrode rows, the third electrode rows, the fourth electrode rows, the first lead wirings, and the second lead wirings; and

a process of molding, after the process of forming the conductor patterns, the electrically insulating transparent resin film into the case body.

The present invention proposes the method for manufacturing the electrostatic capacitive touch panel:

wherein the first electrode rows are provided on one surface side of the principal surface portion;

wherein the second electrode rows are provided on the other surface side of the principal surface portion;

wherein the third electrode rows are provided on a surface side where the electrode rows as origins of the third electrode rows are provided; and

wherein the fourth electrode rows are provided on a surface side where the electrode rows along which the fourth electrode rows are arranged are provided.

The present invention proposes the method for manufacturing the electrostatic capacitive touch panel:

wherein the first electrode rows and the second electrode rows are provided on one surface side of the principal surface portion, the first electrode rows and the second electrode rows being provided with electrically insulative spacers at crossings between the first electrode rows and the second electrode rows; and

wherein the third electrode rows and the fourth electrode rows are provided on one surface side of the side surface portion, the third electrode rows and the fourth electrode rows being provided with electrically insulative spacers at crossings between the third electrode rows and the fourth electrode rows.

The present invention proposes the method for manufacturing the electrostatic capacitive touch panel, wherein the lead wirings passing through the ridgeline portion are arranged on the inside surface of the case body.

The present invention proposes the method for manufacturing the electrostatic capacitive touch panel, wherein center positions of the island-shaped electrodes of the first electrode rows and center positions of the island-shaped electrodes of the second electrode rows are arranged so as to be differently positioned from one another when viewed from a direction orthogonal to the principal surface portion.

The present invention proposes the method for manufacturing the electrostatic capacitive touch panel, wherein the island-shaped electrodes of the first electrode rows and the island-shaped electrodes of the second electrode rows are substantially not overlapped to one another when viewed from a direction orthogonal to the principal surface portion.

The present invention proposes the method for manufacturing the electrostatic capacitive touch panel, further including, after the process of providing the conductor patterns and before the process of molding, a process of forming a visible light shielding layer at a position corresponding to a region outside the principal surface input region of the principal surface portion and/or at a position corresponding to a region outside the side surface input region of the side surface portion.

The present invention proposes the method for manufacturing the electrostatic capacitive touch panel, further including a process of providing the transparent resin layer at a position corresponding to the front surface of the case body.

The present invention proposes the method for manufacturing the electrostatic capacitive touch panel, further including a process of providing the hard coat layer at a position corresponding to the front surface of the case body.

The present invention proposes a touch panel integrated display device including:

a display device; and

an electrostatic capacitive touch panel arranged on a display of the display device.

### Advantageous Effect of Invention

The present invention is capable of obtaining a touch panel having information input regions on a principal surface and a side surface of the touch panel and good operability, and capable of being applicable to an input/output integrated device.

### BRIEF DESCRIPTION OF DRAWINGS

FIG. 1 includes illustrative drawings illustrating processes of manufacturing a touch panel molded body (A).

FIG. 2 is a plan view of a touch panel film (a).

FIG. 3 includes enlarged views (plan views) of main parts of island-shaped electrodes and lead wirings.

FIG. 4 is a plan view of a design print layer.

FIG. 5 is a plan view of the touch panel film (a).

FIG. 6 is a perspective view of a touch panel film heat forming body (α).

FIG. 7 includes a front surface view, a plan view, a left-side surface view, a right-side surface view, and a rear surface view of the touch panel film heat forming body (α).

FIG. 8 is a bottom surface view of the touch panel film heat forming body (α).

FIG. 9 includes illustrative drawings of an input/output integrated device (I).

FIG. 10 includes illustrative drawings of touch panel terminals.

FIG. 11 includes illustrative drawings illustrating processes of manufacturing a touch panel molded body (B).

FIG. 12 includes illustrative drawings of an input/output integrated device (II).

FIG. 13 includes illustrative drawings illustrating processes of manufacturing a touch panel molded body (C).

FIG. 14 includes illustrative drawings of an input/output integrated device (III).

FIG. 15 includes illustrative drawings illustrating processes of manufacturing a touch panel molded body (D).

FIG. 16 is a perspective view of a touch panel film heat forming body (β).

FIG. 17 includes a front surface view, a plan view, a left-side surface view, a right-side surface view, and a rear surface view of the touch panel film heat forming body (β).

FIG. 18 is a bottom surface view of the touch panel film heat forming body (β).

FIG. 19 is a plan view of a design film.

FIG. 20 is a perspective view of a design film heat forming body.

FIG. 21 includes a front surface view, a plan view, a left-side surface view, a right-side surface view, and a rear surface view of the design film heat forming body.

FIG. 22 includes illustrative drawings of an input/output integrated device (IV).

FIG. 23 is an illustrative drawing illustrating a process of manufacturing a touch panel molded body.

FIG. 24 is a plan view of a touch panel film (b).

FIG. 25 is a plan view of a touch panel film (c).

FIG. 26 is a plan view of a touch panel film (d).

FIG. 27 is a plan view of a touch panel film (e).

FIG. 28 is a plan view of a touch panel film (f).

### DESCRIPTION OF EMBODIMENTS

A first invention is directed to an electrostatic capacitive touch panel. A touch panel according to a first embodiment includes a case body. The case body is made of an electrically insulating transparent resin film. The case body is constituted of a principal surface portion, side surface portions, and a hollow portion. The hollow portion is a region defined (enclosed) by the principal surface portion and the side surface portions. The side surface portions are continuous to the principal surface portion. The side surface portions are approximately orthogonal to the principal surface portion. There are at least four side surface portions are approximately orthogonal to the principal surface portion. At least two side surface portions among the at least four side surface portions are approximately orthogonal to a first direction in the principal surface portion. At least two side surface portions among the at least four side surface portions are approximately orthogonal to a second direction in the principal surface portion. The first direction is dissimilar to the second direction. For example, the first direction is approximately orthogonal to the second direction. The principal surface portion includes a principal surface input region. At least one side surface portion of the at least four side surface portions includes a side surface input region. All the side surface portions each may include a side surface input region. Preferably, provided that the number of side surface portions is N (an integer equal to or more than 4), the side surface portions of the number equal to or less than (N−1) or (N−2) each include the side surface input region. The principal surface portion is provided with two or more first electrode rows and two or more second electrode rows. The two or more first electrode rows are arranged at predetermined intervals. The first electrode rows are arranged in the first direction. The two or more second electrode rows are arranged at predetermined intervals. The second electrode rows are arranged in the second direction. The first electrode rows and the second electrode rows each include two or more island-shaped electrodes. The island-shaped electrodes are connected via inter-electrode wirings. The side surface portion including the side surface input region includes one or more third electrode rows and one or more fourth electrode rows. The one or more third electrode rows are provided on an extension of the first electrode rows (and/or the second electrode rows). The extension means, when the principal surface portion (a surface on which the first and the second electrode rows are formed) and the side surface portions (surfaces on which the third and the fourth electrode rows are formed) are in the same plane (e.g., before a film is molded to be formed into a case body), the electrode rows are on the same line (e.g., on a straight line). The fourth electrode rows are arranged in the same direction as the second electrode rows (and/or the first electrode rows). The third electrode rows include one or more island-shaped electrodes in their electrode rows. In a case of a single island-shaped electrode, the single island-shaped electrode is electrically connected to the first electrode rows. That is, the one or more third electrode rows include the single island-shaped electrode and the electrically connected portion. This allows the one or more third electrode rows to be referred to as the electrode rows. In a case of two or more island-shaped electrodes, the island-shaped electrodes are connected via the inter-electrode wirings. The first electrode rows and the third electrode rows are electrically connected to one another. The one or more fourth electrode rows include at least two island-shaped electrodes. The island-shaped electrodes are connected via the inter-electrode wirings. One ends of first lead wirings are electrically connected to ends of the first electrode rows (or the third electrode rows). The other ends of the first lead wirings are arranged on a side surface portion without including the side surface input region. One ends of second lead wirings are electrically connected to ends of the second electrode rows and ends of the fourth electrode rows. The other ends of the second lead wirings are arranged on the side surface portion without including the side surface input region. At least one of the first lead wirings and the second lead wirings pass through a ridgeline portion as a boundary of the neighboring side surface portions.

The first electrode rows are provided on one surface side of the principal surface portion. The second electrode rows are provided on the other surface side of the principal surface portion. The third electrode rows are provided on a surface side where the electrode rows as origins of the third electrode rows are provided. The fourth electrode rows are provided on a surface side where the electrode rows along the fourth electrode rows are arranged. This means also as follows. The first electrode rows and the second electrode rows are provided on different surfaces of the principal surface portion (the film). The different surfaces mean a front surface and a rear surface thereof. The third electrode rows and the fourth electrode rows are formed, in a case where the electrode rows as origins of the electrode rows of the third electrode rows and the fourth electrode rows are first electrode rows, on the surface of the same side as the surface on which the first electrode rows are formed. The third electrode rows and the fourth electrode rows are formed, in a case where the electrode rows as origins of the electrode rows of the third electrode rows and the fourth electrode rows are the second electrode rows, on the surface of the same side as the surface on which the second electrode rows are formed. For example, there are the following cases (1) and (2). (1) The first electrode rows are provided on the front surface side of the principal surface portion (the film). The second electrode rows are provided on the rear surface side of the principal surface portion (the film). The third electrode rows on an extension of the first electrode rows are provided on the front surface side of the side surface portion (the film). The third electrode rows on an extension of the second electrode rows are provided on the rear surface side of the side surface portion (the film). The fourth electrode rows arranged along the first electrode rows are provided on the front surface side of the side surface portion (the film). The fourth electrode rows arranged along the second electrode rows are provided on the rear surface side of the side surface portion (the film). (2) The first electrode rows are provided on the rear surface side of the principal surface portion (the film). The second electrode rows are provided on the front surface side of the principal surface portion (the film). The third electrode rows on an extension of the first electrode rows are provided on the rear surface side of the side surface portion (the film). The third electrode rows on an extension of the second electrode rows are provided on the front surface side of the side surface portion (the film). The fourth electrode rows arranged along the first electrode rows are provided on the rear surface side of the side surface portion (the film). The fourth electrode rows arranged along the second electrode rows are provided on the front surface side of the side surface portion (the film).

There is such a case that the first electrode rows and the second electrode rows are provided together on one surface side of the principal surface portion. There is such a case that the third electrode rows and the fourth electrode rows are provided together on one surface side of the side surface portion. In this case, electrically insulative spacers are provided between the first electrode rows and the second electrode rows at crossings therebetween. The electrically insulative spacers are provided between the third electrode rows and the fourth electrode rows at crossings therebetween. The first electrode rows and the second electrode rows should not be electrically contact to one another. The third electrode rows and the fourth electrode rows should not be electrically contact to one another. To this end, the electrically insulative spacers are provided at the crossings between the rows. The first electrode rows, the second electrode rows, the third electrode rows, and the fourth electrode rows may be provided together on one surface side of the film. The surface on which the first electrode rows and the second electrode rows are provided may be different from the surface on which the third electrode rows and the fourth electrode rows are provided. However, this embodiment requires the electrically insulative spacers. Therefore, the embodiment (wherein the first electrode rows and the second electrode rows are provided on different surfaces) wherein the electrically insulative spacers are not essential components is preferred.

It is preferable that the center positions of the island-shaped electrodes of the first electrode rows and the center positions of the island-shaped electrodes of the second electrode rows are arranged so as to be differently positioned from one another when viewed from the direction orthogonal to the principal surface portion. Specifically, it is preferred that the island-shaped electrodes of the first electrode rows and the island-shaped electrodes of the second electrode rows do not substantially overlap to one another. With the above described configuration, the light transmittance becomes uniform at everywhere in the principal surface input region. That is, a better visual recognition property in the display surface is achieved. A change of an electrostatic capacity is detected effectively at approximately constant detection sensitivity. A relationship between the island-shaped electrodes of the third electrode rows and the island-shaped electrodes of the fourth electrode rows is similar to the relationship between the island-shaped electrodes of the first electrode rows and the island-shaped electrodes of the second electrode rows. However, the third electrode rows and the fourth electrode rows are formed on the side surface portion. Translucency in the side surface portions may not be required as much translucency as in a case of the principal surface portion. Therefore, the island-shaped electrodes of the third electrode rows and the island-shaped electrodes of the fourth electrode rows may partially or fully overlap to one another. As a matter of course, it is preferred that they do not overlap to one another.

Preferably, a visible light shielding layer is provided on a region outside the principal surface input region of the principal surface portion (and/or a region outside the side surface input region of the side surface portion).

Preferably, a transparent resin layer is provided on the front surface of the case body.

Preferably, a hard coat layer is provided on the front surface of the case body.

Preferably, the transparent resin layer is provided on the front surface of the case body, and the hard coat layer is provided on the front surface of the transparent resin layer.

Preferably, a reinforcing frame is provided inside the side surface portion of the case body.

Preferably, the island-shaped electrodes of the principal surface portion are made of net-shaped conductors. More preferably, the island-shaped electrodes of the side surface portions are made of the net-shaped conductors. Preferably, the inter-electrode wirings of the principal surface portion are also made of the net-shaped conductors. More preferably, the inter-electrode wirings of the side surface portions are also made of the net-shaped conductors. Particularly, preferably, the electrode rows of the principal surface portion are made of the net-shaped conductors. The net-shaped conductors achieve better light transmittance. That is, the net-shaped conductors show better visibility. The conductors are made of one or more metals selected from the group consisting of Ag, Au, Cu, and Al. Here, the “two or more metals” mean an alloy.

Preferably, external connection terminals are formed on the side surface portion without including the side surface input region. One of the other ends of the first lead wirings and the other ends of the second lead wirings are connected to the external connection terminals via throughholes. The other one of the other ends of the first lead wirings and the other ends of the second lead wirings are connected to the external connection terminals without passing through the throughholes. Surfaces of the external connection terminals are preferably covered with carbon. The lead wirings passing through the ridgeline portion are preferably arranged on the inner surface side of the case body. Therefore, when the film is molded to be formed into a case body, stretching of the lead wirings hardly occur. In other words, electrical disconnection of the lead wirings hardly occurs.

The second invention is directed to a method for manufacturing an electrostatic capacitive touch panel. The manufacturing method according to the present embodiment is a method for manufacturing the electrostatic capacitive touch panel according to the above described embodiment. The method includes a process of forming conductor patterns. The process of forming the conductor patterns is a process of forming the first electrode rows, the second electrode rows, the third electrode rows, the fourth electrode rows, the first lead wirings, and the second lead wirings on an electrically insulating transparent resin film. The conductor patterns thereof are formed at the same time (or in series). The method includes a process of molding. The process of molding is a process in which the electrically insulating transparent resin film is molded to be formed into the case body, the electrically insulating transparent resin film being provided with the conductor patterns formed thereon.

Preferably, the method further includes a process of providing a visible light shielding layer at a position corresponding to the region outside the principal surface input region of the principal surface portion and/or at a position corresponding to the region outside the side surface input region of the side surface portion after the process of forming the conductor patterns and before the process of molding.

Preferably, the method further includes a process of providing a transparent resin layer at a position corresponding to the front surface of the case body.

Preferably, the method further includes a process of providing a hard coat layer at a position corresponding to the front surface of the case body.

A third invention is directed to a touch panel integrated display device. The device includes a display device. The device includes the electrostatic capacitive touch panel. The electrostatic capacitive touch panel is disposed on a display of the display device.

It is possible to include, after completion of the process of forming the conductor patterns (first process) prior to the process of molding (second process), a process of forming a design print layer for applying a design on one surface of the film on which at least one of the first electrode rows and the second electrode rows are formed, the design print layer shielding visible light. This eliminates necessity of preparation of an additional design film for forming the design print layer. This decreases the number of parts.

It is possible to include a process of forming a transparent resin layer on the exterior surface of the heat-forming body and a process of forming a hard coating layer on the surface of the transparent resin layer by film insert molding and film-in-mold molding. This enables formation of the box body constituting the touch panel and the hard coat layer at one time by concurrently carrying out the film insert molding and the film-in-mold molding, resulting in producing a good manufacturing efficiency.

It is possible to include a process of forming a transparent resin layer on the exterior surface of the heat forming body by the film insert molding. This achieves integration of the heat forming body with the transparent resin layer constituting the box body.

It is possible to include, after completion of the process of forming the transparent resin layer, a process of providing a reinforcing frame in a manner mating with the interior wall of the hollow portion. The reinforcing frame is made of an electrically insulating resin and is formed into a ring shape. This ensures obtainment of a touch panel having sufficient strength against an external force and deformable resistance.

It is possible to include a process of preparing, prior to the second process, a design film having the following features and a process of forming a second heat forming body having the following features by heat forming the design film. The design film is made of an electrically insulating transparent resin, shields visible light, is provided with a design film layer for applying a design as an opaque region, and includes transparent regions formed into the principal surface input region and the side surface input regions via which a position is designated by the indicator. The second heat forming body that corresponds to the box-shaped heat forming body includes a second principal surface portion corresponding to the principal surface portion and second side surface portions corresponding to the respective at least four side surface portions. It is possible to include a process of forming a transparent resin layer between the heat forming body of the film and the second heat forming body by the film insert molding. This enables preparation of design print layers having different types of patterns for different purposes for the heat forming body of the film. As a result, it is possible to obtain a touch panel having the design print layer of a targeted pattern by integrating the heat forming body of the film into the second heat forming body via the transparent resin layer constituting the box body.

It is possible to form the first electrode rows on one surface of the film and to form the second electrode rows on the other surface of the film, the other surface being opposite to the one surface of the film. This ensures formation of the first electrode rows and the second electrode rows via a simple process in comparison with a case where the first electrode rows and the second electrode rows are formed on one surface of the film.

It is possible to form terminals to be connected to the corresponding lead wirings that are connected to the respective ends of the island-shaped electrodes of the respective rows of the plurality of the first electrode rows and the plurality of the second electrode rows on the last ends of the lead wirings on one surface or on the other surface and to form throughholes for the lead wirings or the terminals. This facilitates electrical connection with an external circuit on one surface or on the other surface. This ensures obtainment of the touch panel capable of transmitting signals to the first electrode rows and the second electrode rows.

It is possible to include a process of filling carbon into the throughholes, and further include a process of forming the terminals by the carbon or a process of forming the terminals using the same conductor material that constitutes the lead wirings and subsequently forming a carbon layer as a protective layer covering the terminals. This ensures protection of the terminals. Specifically, in a case where the terminals are made of Ag, the Ag can be protected from being oxidized and migrated.

It is possible to form the third electrode rows on one or both of the two side surface portions in the third direction in which the first electrode rows of the principal surface portion extend, the two side surface portions being approximately orthogonal to the first direction, and to form the electrode rows of the island-shaped electrodes connected one another via the inter-electrode wirings in the second direction in parallel with the second electrode rows of the principal surface portion. It is possible to form the third electrode rows on one of the two side surface portions in the third direction in which the second electrode rows of the principal surface portion extend, the two side surface portions being approximately orthogonal to the second direction, and to form the electrode rows of the island-shaped electrodes connected one another via the inter-electrode wirings in the first direction in parallel with the first electrode rows of the principal surface portion. This ensures formation of the side surface input region where information is input by the indicator on a side surface. It is possible to transmit signals to the electrode rows that are formed each of the principal surface input region and the side surface input regions by a common external circuit.

It is possible to form the first electrode rows, the second electrode rows, and the lead wirings by using any one of Ag, Au, Cu, and Al. This contributes to decrease of probability of electrical disconnection of the lead wirings due to a tensile force applied to the lead wirings and deformation by a compressive force in the formation of the heat forming body.

It is possible to include a process of forming terminals on the last ends of the lead wirings that are formed on at least one of the two side surface portions approximately orthogonal to the first direction and the two side surface portions approximately orthogonal to the second direction. It is possible to include a process of forming terminals on the last ends of the lead wirings that are formed on one of the two side surface portions approximately orthogonal to the second direction. This ensures formation of the lead wirings and the terminals on the side surface portion. Most of the region of the principal surface portion of the touch panel can be formed into the principal surface input region. This achieves minimization of the frame region.

The input/output integrated device of the present invention includes the touch panel manufactured by the above described touch panel manufacturing method and a display device at least partially accommodated in the hollow portion.

In the touch panel of the present invention, when viewed from a direction perpendicular to the surface of the film, the first electrode rows and the second electrode rows are arranged crossing to one another, and the island-shaped electrodes of the first electrode rows and the island-shaped electrodes of the second electrode rows are arranged separately alternately into a two-dimensional lattice-pattern. This ensures uniform light transmittance at everywhere within the principal surface input region that also serves as a display. Thus, this ensures better visibility of the display surface. It is possible to efficiently detect a change of electrostatic capacity over the entire range of the principal surface input region at approximately constant detection sensitivity.

It is possible for the film to include, on one surface thereof, a design print layer that is formed on a surface of a part of the principal surface portion and at least partially on a surface of each of the at least four side surface portions in order to shield visible light and apply a design. Further, it is possible for the heat forming body of the film to include the design print layer. Accordingly, with the design print layer, it is possible to leave the principal surface input region on the principal surface portion and the side surface input regions on the side surface portions as approximately transparent openings having light permeability. Further, it is possible to display information and decoration and/or design on remaining portions of the touch panel.

It is possible to include a transparent resin layer formed on an exterior surface of the heat forming body of the film and a hard coating layer formed on a surface of the transparent resin layer. This enables formation of a box body constituting the touch panel with the transparent resin layer, protection of the inside of the touch panel, and protection of the outermost surface of the touch panel by the hard coat layer.

It is possible to include the transparent resin layer formed on the exterior surface of the heat forming body of the film without including the hard coat layer. This achieves integration of the transparent resin layer constituting the box body and the heat forming body of the film.

It is possible to include an electric insulating resin-made ring-shaped reinforcing frame that is provided in a manner mating with the interior wall of the hollow portion. This ensures obtainment of a touch panel having a sufficient strength against an external force and deformable resistance.

It is possible to heat-form a design film having the following features to obtain a second heat forming body having the following features. The design film is made of an electrically insulating transparent resin, shields visible light, is provided with a design film layer for applying a design as an opaque region, and includes transparent regions formed into the principal surface input region and the side surface input regions via which a position is designated by the indicator. The second heat forming body that corresponds to the box-shaped heat forming body includes a second principal surface portion corresponding to the principal surface portion and second side surface portions corresponding to the respective at least four side surface portions. It is further possible to sandwich a transparent resin layer formed by the film insert molding between the heat forming body of the film and the second heat forming body. This enables preparation of design print layers having different types of patterns for different purposes for the heat forming body. As a result, it is possible to obtain a touch panel having the design print layer of a targeted pattern by integrating the transparent resin layer constituting the box body with the second heat forming body.

It is possible to form the first electrode rows on one surface of the film and to form the second electrode rows on the other surface of the film, the other surface being opposite to the one surface of the film. This ensures formation of the first electrode rows and the second electrode rows by a simple process in comparison with a case where the first electrode rows are formed on one surface of the film and the second electrode rows are formed on the other surface of the film, the other surface being opposite to the one surface of the film.

It is possible to form terminals to be connected to the respective lead wirings that are connected to the corresponding tail ends of the island-shaped electrodes of the respective rows of the plurality of the first electrode rows and the plurality of the second electrode rows on the last ends of the lead wirings on one surface or on the other surface and to form throughholes for the lead wirings or the terminals. This facilitates electrical connection with an external circuit at one surface or at the other surface. This ensures transmission of signals to the first electrode rows and the second electrode rows.

It is possible to fill carbon into the throughholes, to form the terminals with the carbon or with a material identical to the electrically conductive material that forms the lead wirings, and to form a carbon layer as a protective layer covering the terminals. This ensures protection of the terminals. Specifically, in a case where the terminals are made of Ag, it is possible to prevent Ag from being oxidized or migrated.

It is possible to form the third electrode rows on one or both of the two side surface portions in the third direction in which the first electrode rows of the principal surface portion extend, the two side surface portions being approximately orthogonal to the first direction, and to form the electrode rows that are made of the island-shaped electrodes connected to one another via the inter-electrode wirings in the second direction in parallel with the second electrode rows of the principal surface portion. The third electrode rows are formed on one of the two side surface portions in the third direction in which the second electrode rows of the principal surface portion extend, the two side surface portions being approximately orthogonal to the second direction, and electrode rows are formed in the first direction in parallel with the first electrode rows of the principal surface portion, the electrode rows being made of the island-shaped electrodes connected to one another via the inter-electrode wirings. This achieves formation of the side surface input region into which information is input by the indicator on the side surface. This also ensures transmission of signals using a common external circuit with respect to the electrode rows formed on each of the principal surface input region and the side surface input region.

It is possible to form the terminals on the last ends of the lead wirings that are formed on at least one of the two side surface potions approximately orthogonal to the first direction and the one of the two side surface portions approximately orthogonal to the second direction. It is possible to form the terminals on the last ends of the lead wirings formed on one of the two side surface portions approximately orthogonal to the second direction. This ensures formation of the lead wirings and the terminals on the side surface portions. Therefore, it is possible to form the most of the region of the principal surface portion of the touch panel into the principal surface input region. This minimizes the frame region.

It is possible to form the first electrode rows, the second electrode rows, and the lead wirings of any one of Ag, Au, Cu, and Al. This contributes to decrease of probability of electrical disconnection of the lead wirings due to a tensile force applied to the lead wirings and deformation due to a compressive force in the process of forming the heat forming body.

The input/output integrated device of the present invention includes a touch panel including as a main component a touch panel molded body with a principal surface input region and a side surface input region and a display device at least partially accommodated in the hollow portion of the touch panel. The input/output integrated device of the present invention is excellent in operability.

### DESCRIPTION OF TERMS

Terms in the present embodiments are described below.

“Touch Panel”: A touch panel is formed into one piece with a display device. The touch panel is capable of detecting a touch operation by the user without, for example, an image display of the display device being disturbed. The touch panel includes the maximum area portion (principal surface portion: principal surface) and side surface portions (side surfaces) continuous to the maximum area portion. For example, there are, preferably, four side surface portions. The touch panel has a rectangular shaped hollow structure (hollow space, hollow portion) therein defined by the principal surface portion and the side surface portions (four side surface portions). Therefore, the touch panel results in being formed into a case-shaped (box-shaped) three-dimensional product. The principal surface portion and the side surface portions are provided, as required, with island-shaped electrodes, inter-electrode wirings, lead wirings, and terminals formed thereon. The touch panel is provided with input regions formed thereon.
“Touch Panel Film”: The touch panel film is made of an electrically insulating transparent resin film. The electrically insulating transparent resin film is provided, as required, with island-shaped electrodes, inter-electrode wirings, lead wirings, terminals, and a design print layer formed thereon. There is a case where the design print layer is not formed.
“Touch Panel Molded Body”: The touch panel molded body is a resin molded product formed such that, for example, an electrically insulating transparent resin film with, for example, the island-shaped electrodes is molded by various molding methods.
“Indicator”: The indicator is an input device such as a conductive touch pen. Alternatively, it is a user's finger. The indicator is used by the user to indicate an arbitrary position of an input region in a principal surface portion (side surface portions) of the touch panel.
“Touching (Touch Input)”: This means to allow the indicator to touch (or approach) the touch panel.
“Touch Surface”: The touch surface is a surface of the touch panel that the indicator touches (or approaches).
“Touched Position”: The touched position is a position indicated by the indicator touching (or approaching).
“Principal Surface Input Region”: The principal surface input region is a region in the principal surface portion in which a position is designated by the indicator.
“Side Surface Input Region”: The side surface input region is a region in the side surface portion in which a position is designated by the indicator.
“Design Print Layer”: The design print layer is formed on an electrically insulating transparent resin film. The region on which the design print layer is formed becomes an opaque region. The opaque region shields visible light. The opaque region is provided with a design. A transparent region on which no design print layer is formed is an input region. The design print layer is formed on an outside (periphery: window frame portion: frame portion) of a principal surface input region or a side surface input region of the touch panel. Information is displayed on the design print layer by means of desired character information and marks and pictures.
“Design Film”: The design film is a film on which the design print layer is formed.
“Hard Coat Layer”: The hard coat layer is a protective layer providing predetermined strength (hardness) to the outermost layer (a transparent resin case or a design film) of the touch panel. The protective layer provides durability, whether resistance, and shock resistance. For example, the protective layer is made of an ultraviolet curing resin.
“Island-shaped Electrode”: The island-shaped electrode is an electrode for detecting a change of electrostatic capacity caused by touching (or approaching) of the indicator. The island-shaped electrode is also referred to as a contact sensing electrode or simply as a sensing electrode. The island-shaped electrode is formed, for example, into a triangular shape, a square shape, a rectangular shape, a diamond shape (having a vertical angle of 90° or other than 90°), an N-cornered (N is an integer equal to or more than 5) polygon shape, a circular shape, or an oval shape.
“Inter-electrode Wiring”: The inter-electrode wiring is a conductor (wiring) which electrically connects the neighboring island-shaped electrodes to each other.
“Lead Wiring”: The lead wiring is a conductor (wiring) which establishes electrical connection between the island-shaped electrode and a touch panel terminal.
“Net-shaped Conductor”: The net-shaped conductor is a conductor (wiring) having a net-shape. The island-shaped electrode is the net-shaped conductor. The inter-electrode wiring is, preferably, also the net-shaped conductor. The lead wiring may also be the net-shaped conductor.
“Net-shaped Conductor Pattern”: The net-shaped conductor pattern is a conductor pattern formed into a net shape.
“Touch Panel Terminal”: The touch panel terminal is an input/output terminal connected to a last end of the lead wiring formed on the side surface portion of the touch panel.
“Heat Forming”: The heat forming is to heat and soften a film to form it into a case shape (box shape) by, for example, vacuum molding (to evacuate a space between a mold and a film to let the film to tightly contact the mold in order to mold the film) or air pressure molding (to heat and soften a film to cause the film to follow a shape of the mold by means of a compressive force of air in order to mold the film).
“Heat Forming Body”: The heat forming body is a molded body formed by heat forming.
“Touch Panel Film Heat Forming Body”: The touch panel film heat forming body is a molded body formed by heating a touch panel film.
“Design Film Heat Forming Body”: The design film heat forming body is a molded body formed by heating a design film.
“Film-in-mold Molding”: The film-in-mold molding is to form a desired layer (e.g., a temporarily harden hard coat layer) on a releasable film after being processed by a mold release agent (separating material). The film is inserted into a mold and, subsequently, a melt flow state-molding resin is injected into the mold for solidification thereof. This enables obtainment of a molded body with a desired layer being transferred onto a surface of the molded body.
“First Direction”: In a case where the principal surface input region of the touch panel has a rectangular shape, a direction along a long side of the principal surface input region is referred to as a first direction. In the drawing, a y-direction (lateral direction) is the first direction. In a case where the principal surface input region has a square shape, a direction along any one of the sides of the principal surface input region is the first direction.
“Second Direction”: In a case where the principal surface input region of the touch panel has a rectangular shape, a direction along a short side of the principal surface input region is referred to as a second direction. In the drawing, an x-direction (vertical direction) is the second direction.
“Third Direction”: A direction perpendicular to the paper including illustrations (depth direction) is referred to as a third direction. In the drawing, a z-direction is the third direction. For example, the first direction, the second direction, and the third direction cross one another. However, a strict right-angle crossing is not required here. For example, the directions may cross one another at approximate angles within a range between 85° and 95°.

Hereinafter, referring to the attached drawings, the embodiments of the present invention will be described. However, the present invention may have any structure in so far as the above described functions and effects are satisfactory produced. The present invention will not be limited to the below described embodiments. The attached drawings are only illustrative for easy understanding of the present invention. There may be inaccuracy in a reduced scale thereof.

### Embodiments

Initially, common terms are described below.

<Projection-Type Electrostatic Capacitance Coupling-Type Touch Panel>

The present invention relates, specifically, to a projection-type electrostatic capacitance coupling-type touch panel. More specifically, the present invention relates to an apparatus including the touch panel assembled into a display device (input/output integrated device). The touch panel is used as an input device for operating electronic equipment. The touch panel is mounted to a display surface of a display device (e.g., liquid crystal display). The touch panel is a touch panel molded body. The touch panel is a device with which the user performs various operations (e.g., input operation) of the electronic equipment by touching (approaching: position indication) to a touch surface by an indicator (e.g., a conductor such as a touch pen and a finger) according to display contents of the display device visually recognized through the touch surface (e.g., principal surface) of the molded body.

The touch panel is provided with island-shaped electrodes on an electrically insulating transparent film of the touch panel. For example, the island-shaped electrodes are provided on both surfaces (a front surface and a rear surface) of the film. One or more island-shaped electrodes are provided on the front surface of the film in an x-direction (or in a y-direction). One or more island-shaped electrodes are provided on the rear surface of the film in the y-direction (or the x-direction). As viewed from a direction perpendicular to the film, the island-shaped electrodes are arranged to be formed into a (two-dimensional) lattice shape. The island-shaped electrodes formed on the front surface of the film and the island-shaped electrodes formed on the rear surface of the film are arranged so as not to substantially overlap to one another. A multitouch detection becomes possible with the island-shaped electrodes arranged as described above by sequentially detecting a capacitance change at a position (x, y).

The island-shaped electrodes are formed on the principal surface of the touch panel molded body and the side surface that crosses the principal surface of the touch panel molded body. An information input region for inputting information by a user's touch operation includes a principal surface input region formed on the principal surface and a side surface input region formed on the side surface. A touch input region is formed on both of the principal surface and the side surface.

<Common Terms of Main Components of Touch Panel [Touch Panel Molded Bodies (A) to (D)]>

Common terms of the touch panel [below mentioned touch panel molded bodies (A) to (D)] will be described below.

(Touch Panel Molded Body)

A touch panel is a heat forming body (touch panel molded body) of a touch panel film. The touch panel molded body includes a principal surface ((xy) surface in an x-y-z coordinate system) having a maximum area, side surfaces approximately crossing to the principal surface ((xz) surfaces in the coordinate system), and side surfaces approximately crossing to the principal surface ((yz) surfaces in the coordinate system). For example, there is one (xy) surface. For example, there are two (xz) surfaces. For example, there are two (yz) surfaces. A region defined by the principal surface and the side surfaces is a hollow portion (hollow space).

Examples of a transparent resin for forming the touch panel include a thermoplastic resin (e.g., an acrylic resin, a polycarbonate resin, a polyester resin, and a polyolefin resin) or a thermosetting resin (e.g., an epoxy resin, a urea resin, and a silicone resin).

Island-shaped electrodes are formed on at least one of the (xz) surfaces and the (yz) surfaces and the (xy) surface. The neighboring island-shaped electrodes are connected in series via inter-electrode wirings.

A plurality of island-shaped electrode rows arranged in the y-direction is formed on a front surface of the (xy) surface in the x-direction. A plurality of island-shaped electrode rows arranged in the x-direction is formed on a rear surface of the (xy) surface in the y-direction. Here, the arrangement may be reversed in the front surface and the rear surface.

In a case where the island-shaped electrode rows are formed on the (xz) surfaces, the island-shaped electrode rows on the (xz) surfaces are formed, for example, in such a manner that a film on which the island-shaped electrode rows arranged in the y-direction are formed is bent into a 90° angle. In a case where the island-shaped electrode rows are formed on the (yz) surfaces, the island-shaped electrode rows on the (yz) surfaces are formed, for example, in such a manner that a film on which the island-shaped electrode rows arranged in the x-direction are formed is bent into a 90° angle. The island-shaped electrode rows on the (xy) surface are a portion of the island-shaped electrode rows formed on the film surface. The island-shaped electrode rows on the (xz) surfaces are portions of the island-shaped electrode rows formed on the film surface. The island-shaped electrode rows on the (xz) surfaces are, for example, on an extension of the island-shaped electrode rows on the (xy) surface. The island-shaped electrode rows on the (yz) surfaces are portions of the island-shaped electrode rows formed on the film surface. The island-shaped electrode rows on the (yz) surfaces are, for example, on an extension of the island-shaped electrode rows on the (xy) surface.

The island-shaped electrodes of the island-shaped electrode rows formed on the front surface side of the film and the island-shaped electrodes of the island-shaped electrode rows formed on the rear surface side of the film do not substantially overlap to one another. In terms of light permeability (visibility), it is preferable that a region (area) at which the island-shaped electrodes on the front surface side and the island-shaped electrodes on the rear surface side overlap one another is as small as possible. There is no overlapping region (area) therebetween. However, in terms of the electrostatic capacity, it is preferable that a region (area) where the island-shaped electrodes do not overlap one another is as small as possible. There is a little region (area) at which the island-shaped electrodes do not overlap one another.

Lead wirings are formed on at least one of the (xz) surfaces and the (yz) surfaces. Preferably, the lead wirings are formed across one (xz) surface and one (yz) surface (the two surfaces are neighboring and continuous to each other). The lead wirings are connected, for example, to the island-shaped electrode rows on the (xz) surface. The lead wirings are connected, for example, to the island-shaped electrode rows on the rear surface of the (yz) surface. Terminals are formed at tail ends of the lead wirings.

The terminals are connected to one FPC joining terminals of a flexible printed circuit board (FPC)). The other FPC joining terminals are connected to a touch panel control/signal processing circuit.

The touch panel is formed into a projection-type electrostatic capacity coupling-type touch panel. The touch panel has a function of the input device through which various types of information is input. A principal surface of the touch panel is provided, for example, with a rectangular principal surface input region. At least one of the side surfaces ((xz) surfaces, (yz) surfaces) is provided with a rectangular side surface input region. Touched positions indicated by the indicator's touching on the principal surface input region and the side surface input region are sensed by detecting a change of electrostatic capacity between the island-shaped electrodes formed on the front surface side of the touch panel and the island-shaped electrodes formed on the rear surface side of the touch panel by a self capacitance detection method or a mutual capacitance detection method.

An active region is formed on the principal surface of the touch panel. As a case requires, a non-active region is provided thereon. The active region is a region into which various types of information are input via touching. The active region is a transparent translucent region (principal surface input region: touch input region) through which a touch input is detected. The non-active region is formed on a frame-shaped region (frame region) enclosing the principal surface input region. The non-active region is a design region (decoration region) on which non-light transmissive design print layer is formed. Even if the touch input is made on the non-active region, this touch input is not detected. The active region and the non-active region are formed on the side surface of the touch panel. The active region on the side surface is a side surface input region.

Detection of the touched position on the principal surface input region touched by the indicator by means of the self capacitance detection method (mutual capacitance detection method) will be described below.

In the self capacitance detection method, a voltage signal is supplied sequentially to the island-shaped electrode rows arranged in the x-direction on the principal surface ((xy) surface) in order to detect the touched position. A voltage signal is supplied sequentially to the island-shaped electrode rows arranged in the y-direction on the principal surface ((xy) surface) in order to detect the touched position. Here, capacitance between the island-shaped electrode rows A arranged in the x-direction of the principal surface facing the touched position and the island-shaped electrode rows B arranged in the y-direction of the principal surface and a GND (ground) increases. Therefore, waveforms of transmitted signals from the island-shaped electrode rows A and the island-shaped electrode rows B become waveforms different from waveforms of transmission signals transmitted from the island-shaped electrode rows A′ in the x-direction and the island-shaped electrode rows B′ in the y-direction other than a combination of the island-shaped electrode rows A in the x-direction and the island-shaped electrode rows B in the y-direction. The touch panel control/signal processing circuit calculates the touched position based on the transmission signals supplied from the island-shaped electrode rows (the island-shaped electrode rows arranged in the x-direction of the principal surface and the island-shaped electrode rows arranged in the y-direction of the principal surface).

In the mutual capacitance detection method, a voltage signal is supplied sequentially, for example, to the island-shaped electrode rows arranged in the x-direction of the principal surface in order to detect the touched position. Then, sensing (detection of the transmission signal) is performed sequentially with respect to the island-shaped electrode rows arranged in the y-direction of the principal surface. A stray capacitance of the indicator is applied in series with respect to the parasitic capacitance between the island-shaped electrode rows A arranged in the x-direction facing the touched position and the island-shaped electrode rows B arranged in the y-direction. The waveforms of the transmission signals from the island-shaped electrode rows B arranged in the y-direction are different from the waveforms from the island-shaped electrode rows B′ in the y-direction other than the island-shaped electrode rows B in the y-direction. Therefore, the touch panel control/signal processing circuit calculates the touched position based on the order of the island-shaped electrode rows arranged in the x-direction to which the voltage signal is supplied and the transmission signals from the island-shaped electrode rows arranged in the y-direction to which the voltage signal is supplied.

Employment of the self capacitance detection type (or the mutual capacitance detection type) touched position detection method ensures sensing of touched positions when two indicators touch (or approach) the principal surface input region at the same time.

Similarly, it becomes possible to detect the touched position of the side surface input region touched by the indicator.

(Touch Panel Film on which Net-Shaped Conductors are Formed and Design Film on which Design Print Layer is Formed)

The touch panel film (design film) is made of an electrically insulating transparent resin film. Examples of a material of the film include ester based resins (e.g., polyethylene-telephthalate (PET), polyethylene naphthalane (e.g., PEN), olefin resin (e.g., polyethylene (PE), polypropylene (PP)), vinyl resin, polyvinyl acetate (e.g., EVA), polycarbonate (PC), triacetylcellulose (TAC), polymethyl methacrylate (PMMA), polyethersulfone (PES), polyether ether ketone (PEEK), polyamide (PA), polyimide (PI), polystyrene (PS), ring-shaped olefin polymer (COC), polyurethane (PU), and polyvinyl alcohol (PVA). A typical example thereof is the PET.

A thickness of the film is, for example, within a range between 10 μm and 300 μm. The thickness is, however, not limited to this. In view of light transmittance and mechanical strength, the thickness is preferably within a range between 30 μm and 150 μm.

(Method for Forming Net-Shaped Conductor)

A typical method for forming a net-shaped conductor (meshed conductor) will be described below. The island-shaped electrodes and the inter-electrode wirings are preferably made of the net-shaped conductors. The lead wirings may also be made of the net-shaped conductors. A net shape (i.e., that has a high aperture ratio) produces better light transmittance.

(1) Method by Printing of Conductive Ink

A conductive ink containing conductive nanoparticles and binder is applied to a surface of a transparent film to be formed into a net shape. For example, a printing (e.g., screen printing, ink jet printing, gravure printing, offset printing, flexo printing, and dispenser printing) method is employed for this.

The conductive nanoparticles are conductive particles having an average particle diameter of, for example, 2 μm or less (preferably, 200 to 500 nm). Examples of a material for the particles include Ag, Au, Pt, Cu, Al, or carbon. The binder is, for example, polyether resin.

The net-shaped conductor is capable of being printed to be formed using the conductive ink containing conductive polymer. Examples of the conductive polymer include poly (3,4-ethylene dioxythiophene)/polystyrene sulfonate (PEDOT/PSS), polyaniline, polyacetylene, and polyphenylene vinylene.

(2) Method by Etching Conductive Thin Film

A conductive thin film is formed on a surface of a resin film. A net-shaped resist pattern is formed on the conductive thin film. The conductive thin film exposed from the resist pattern is removed by etching. This results in obtainment of a net-shaped conductor. The thin film is formed by a vacuum deposition method, a sputtering method, an ion plating method, and a gold impregnation method. The thin film may be a metallic thin film bonded to the resin film. The conductive thin film is a thin film made of, for example, Au, Ag, Cu, and Al.

The conductive thin film may be a film made of conductive polymer. An example of the conductive polymer includes the high polymer.

(3) Method by Metallic Thin Film Deposition Method Using Mask

The metallic thin film is a thin film made of, for example, Au, Ag, Cu, or Al.

(4) Method by Conductive Silver Forming Method Using Silver Salt

A sensitive material containing photosensitive silver halide and binder is applied to a surface of the resin film, followed by pattern exposure and development thereof. A thin line made of silver is formed on an exposed portion, whereas, a light permeable portion is formed on unexposed portion. This enables formation of the net-shaped conductor (Ag).

(Line Width, Pitch, and Thickness of Net-Shaped Conductor (Conductor Thin Line))

A line width of a conductor thin line, a pitch of the conductor thin line, a thickness of the conductor thin line for constituting the island-shaped electrodes and the inter-electrode wirings are, for example, between 10 μm and 50 μm, between 100 μm and 1000 μm, and between 2 μm and 10 μm, respectively. In such a net-shaped conductor, the conductor thin line has a thin line width and a large pitch with respect to the line width. This makes the net-shaped conductor less recognizable and ensures better visibility.

The aperture ratio of the net-shaped conductor (island-shaped electrodes, inter-electrode wirings) is preferably equal to or more than 90% in terms of a brightness of a display screen. The aperture ratio is obtained from (a total area of an outer shape of the net-shaped conductor−an area of a conductor portion)/(the total area of the outer shape of the net-shaped conductor).

A size of the outer shape of each island-shaped electrode is, for example, within a range between 2 mm and 5 mm. A width of the outer shape of each inter-electrode wiring is smaller than the outer shape of each island-shaped electrode.

A distance (distance between sides shaping the outer shape of the island-shaped electrode) between neighboring island-shaped electrodes (between the island-shaped electrodes mutually connected via the inter-electrode wirings) is, for example, within a range between 20 μm and 100 μm.

A dimension, a pitch, and a thickness of the lead wirings (conductor thin lines) may be the same as those of the island-shaped electrodes or may be different from those of the island-shaped electrodes. For example, a line width, the pitch, and the thickness of the conductor thin line are within a range between 50 μm and 200 between 100 μm and 1000 μm, and between 10 μm and 50 μm, respectively.

The lead wirings are wirings for transmitting signals from the island-shaped electrode rows to an external circuit. The lead wirings are made of a conductive material having high conductivity. The lead wirings are formed into a net shape. However, this is not limitative. The lead wirings may be formed into another shape such as a solid wiring.

A touch panel terminals formed as extensions of the lead wirings and isolated wirings (isolated wirings formed, to which the lead wirings formed on one surface of the touch panel film are connected via the conductors within throughholes formed in the touch panel film, on the other surface of the touch panel film) have a net shape. However, this is not limitative. The touch panel terminals and the isolated wirings may be formed into a solid wiring.

(Design Print Layer)

A design print layer is a layer provided with printing of a non-light transmissible window frame and void characters. The design print layer is provided on a region (nonactive region) outside the input region (active region: touch input region).

The design print layer is formed on a design film. An electrically insulating transparent resin film that is typically used for a touch panel film is used as the design film. A design print layer is formed on one surface of the film.

The design print layer is formed by printing (e.g., screen printing, offset printing, flexo printing, gravure printing, and ink jet printing). A print thickness is, for example, within a range between 2 μm and 10 μm.

The design print layer may be formed directly on the touch panel film on which net-shaped conductor patterns are formed. A region inside the design print layer is a display area (input region). In this case, the design film is not employed.

The design film on which the design print layer is formed and the touch panel film on which the net-shaped conductor patterns are formed may be laminated each other. For example, a below mentioned touch panel molded body (D) may be employed here.

(Hard Coat Layer)

A hard coat layer may be provided on the outermost layer of the touch panel (transparent resin case (or design film)). This hard coat layer has a preferable thickness of a range between 1 μm and 20 μm. An example of a material of the hard coat layer includes an organic-inorganic hybrid hard coat agent Acier produced by NIDEK CO., LTD.

<Common Terms for Input/Output Integrated Devices (I), (II), (III), and (IV)>

Common terms for input/output integrated devices (I), (II), (III), and (IV) will be described below.

(Input/Output Integrated Device)

The touch panel and the display device are assembled to be formed into an input/output integration device. The input/output integration device includes a touch panel molded body, a display device, connection conductors, a touch panel control/signal processing circuit, a display unit control/signal processing circuit, an input/output integration device control/signal processing circuit. An example of the connection conductors includes a flexible printed circuit board (FPC) for establishing electrical connection between the touch panel molded body and the display device. An example of the display device includes a liquid crystal display (LCD).

The touch panel control/signal processing circuit is drive-controlled by a driving signal transmitted from the input/output integration device and processes a signal from the touch panel molded body. The signals from the touch panel molded body or a result of processing the signals is transmitted to the display device. Signal processing that is to be required for displaying the result will be carried out. The processing result is displayed on the display device (display surface) drive-controlled by the display unit control/signal processing circuit. The input/output integration device control/signal processing circuit controls the input/output integration device as a whole. The input/output integration device control/signal processing circuit is a circuit for executing signal processing for the device as a whole. The input/output integration device control/signal processing circuit transmits control signals to the touch panel control/signal processing circuit and the display unit control/signal processing circuit to control operations of the circuits.

The display device to be assembled with the touch panel is an output device for outputting images including character information and image information. The display device includes a display surface and a display unit control/signal processing circuit. The display surface includes a display area for outputting and displaying the images and a non-display area enclosing the display area. The display unit control/signal processing circuit processes information about the images to be output and displayed. The display unit control/signal processing circuit subsequently drives the display device based on the image information. The display device displays predetermined images on a display surface based on the control signal of the display unit control/signal processing circuit.

A principal surface of the touch panel is arranged above the display device (display surface) facing thereto. A principal surface input region (touch input region, active region) provided on the principal surface of the touch panel is arranged facing the display area of the display device (display surface). The nonactive region provided on the principal surface of the touch panel is arranged facing the display area of the nondisplay surface of the display device. The user observes an image displayed on the display surface of the display device via a translucent principal surface input region.

(Dimensions of Input/Output Integrated Device)

An example of the electronic equipment including the input/output integrated device includes a portable terminal having a function of telephone. The terminal has outer dimensions of a lateral length within a range between 70 mm and 80 mm, a longitudinal length within a range between 130 mm and 150 mm, and a thickness within a range between 8 mm and 100 mm. Each of the display area of the display device (display surface) and the principal surface input region of the touch panel corresponding to the display device (display surface) has a rectangular shape. For example, the rectangular shape is formed to have the dimensions of a lateral length within a range between 60 mm and 70 mm and a longitudinal length within a range between 90 mm and 120 mm. The side surface input region has a rectangular shape. For example, a lateral side surface thereof has dimensions of a thickness within a range between 8 mm and 10 mm and a lateral length within a range between 50 mm and 60. For example, a longitudinal side surface thereof has dimensions of a thickness within a range between 8 mm and 10 mm and a longitudinal length within a range between 80 mm and 110 mm.

The touch panel is used in combination with the display device. The touch panel includes the principal surface input region and the side surface input region. The touch input region is provided on a plurality of surfaces. Most of the lead wirings are formed on the side surface. Most of the principal surface is occupied by the principal surface input region. Therefore, the principal surface input region has a large display surface. The touch panel is used for a display device having a large display surface. The touch panel is suitable for an input/output integration device having a large display surface. These devices are excellent in operability.

(Example of Display Device)

Examples of the display device to be assembled with the touch panel include a liquid crystal display device, an organic LED display device, a nonorganic LED display device, an electrochromic display, a prasma display device, and a field emission display device.

(Example of Electronic Equipment to which Input/Output Integrated Device is Applied)

The input/output integrated device is used for industrial machines such as general appliances (e.g., a washing machine, a refrigerator, and a television), a cellular phone, a car navigation system, transportable navigation equipment, a portable media player, an electronic book reader, a tablet terminal, a game machine, an electronic dictionary, an automatic teller machine, and various types of physical and chemical appliances.

While referring to an output display screen of the input/output integrated device, the user touches the output display screen by an indicator (an input tool such as a touch pen and a finger), the output display screen being an input surface. The touching indicates an arbitrary position of the output display screen. This allows selection of preliminary set various operation conditions on the output display screen. Alternatively, this allows the various operation conditions to be numerically input to the output display screen. A target key is selected from a plurality of keys preliminary set to the side surface input region such that each of the plurality of keys corresponds to each of the various operation conditions. Then, the driving condition corresponding to the selected key is instructed to various electronic devices.

The touch panel input region is formed on each of the principal surface and the side surface of the touch panel. Therefore, the operation condition is capable of being indicated by using either one of the surfaces of the principal surface input region and the side surface input region. This shows high operability.

Hereinafter, the touch panel, the method for manufacturing the touch panel, and the input/output integrated device will be described.

<Method for Manufacturing Touch Panel Made of Touch Panel Molded Body (A), Touch Panel, and Input/Output Integrated Device (I) Including Touch Panel and Display Device>

### <Touch Panel Molded Body (A)>

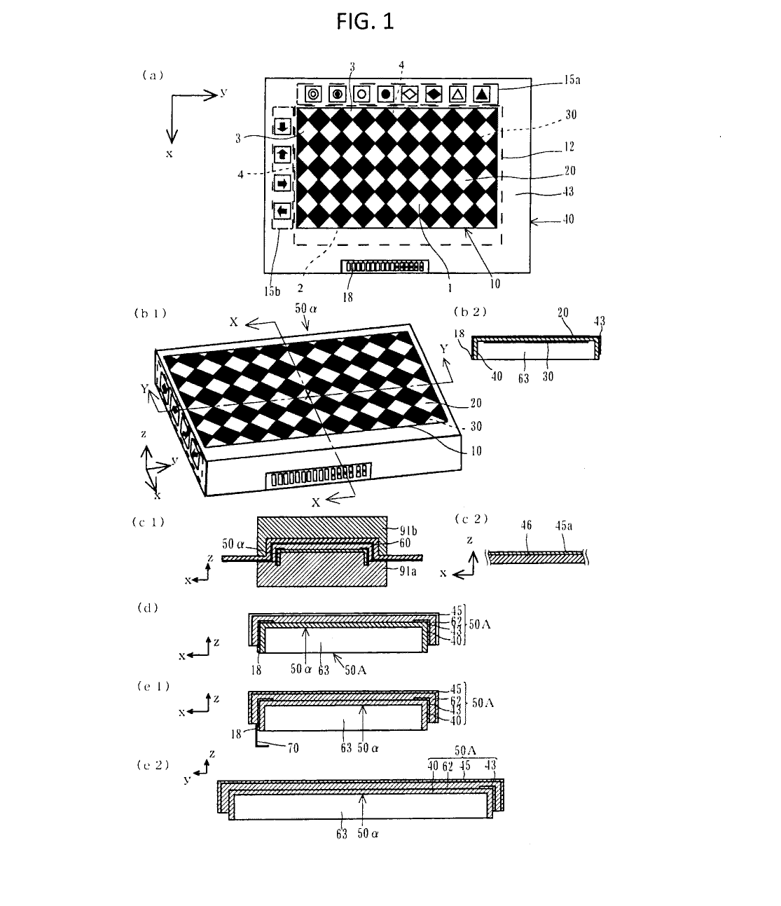

A touch panel (touch panel molded body (A)) is manufactured through the below mentioned manufacturing processes (see FIG. 1).

FIG. 1 illustrates processes of manufacturing the touch panel molded body (A). FIG. 1(a) is a plan view of a film resulting from a process of forming the island-shaped electrodes and the lead wirings on the touch panel film and a process of forming the design print layer. FIG. 1 (b1) is a perspective view of a touch panel film heat forming body (touch panel molded body) (α) resulting from a process of heat forming the film of FIG. 1 (a). FIG. 1 (b2) is a cross sectional view of the touch panel film heat forming body (α) in FIG. 1(b1) taken along the line X-X. FIG. 1(c) is a cross sectional view of the touch panel film heat forming body (α) in a process of film insert-molding and film-in-mold molding. FIG. 1(d) is a cross sectional view of the touch panel film heat forming body (α) taken along the line X-X in a process of hardening a hard coat material into a full-cured state after a molded body is taken out from a mold. FIG. 1(e1) is a cross sectional view of a flexible printed circuit board (FPC)) connected-touch panel molded body (A) taken along the line X-X. FIG. 1(e2) is a cross sectional view of the flexible printed circuit board (FPC)) connected-touch panel molded body (A) taken along the line Y-Y.

Island-shaped electrodes, inter-electrode wirings, lead wirings, touch panel terminals 18 of tail ends of the lead wirings, and throughholes 19 are formed on a front surface and a rear surface of a touch panel film 40 with a predetermined pattern (see, FIG. 1(a)). The inter-electrode wirings, the lead wirings, and the throughholes are not illustrated in FIG. 1(a). The throughholes 19 are formed, respectively, in the touch panel terminals 18 of ends of lead wirings 32 in a y-direction. The island-shaped electrodes detect a touched position.

20 denotes island-shaped electrodes formed on the front surface of the touch panel film 40, the island-shaped electrodes being arranged in an x-direction. 30 denotes island-shaped electrodes formed on the rear surface of the touch panel film 40, the island-shaped electrodes 30 being arranged in the y-direction. 21 and 31 denote wirings (inter-electrode wirings) for establishing connection between the island-shaped electrodes. The inter-electrode wirings 21 are formed on the front surface of the touch panel film 40, the inter-electrode wirings being arranged in the x-direction. The inter-electrode wirings 31 are formed on the rear surface of the touch panel film 40, the inter-electrode wirings being arranged in the y-direction. Electrode rows 1, 2, 3, and 4 are constituted of the island-shaped electrodes and the inter-electrode wirings. The electrode rows 1 are formed on the front surface of the touch panel film 40 at a center position of the touch panel film 40 ((xy) surface in FIG. 1(b1)). The electrode rows 2 are formed on the rear surface of the touch panel film 40 at a center position of the touch panel film 40 ((xy) surface in FIG. 1(b1)). The electrode rows 3 are formed on the front surface of the touch panel film 40 at a left position of the touch panel film 40 ((xz) surface in FIG. 1(b1)) and at an upper position of the touch panel film 40 ((yz) surface in FIG. 1(b1)). The electrode rows 4 are formed on the rear surface of the touch panel film 40 at the left position of the touch panel film 40 ((xz) surface in FIG. 1(b1)) and at an upper position of the touch panel film 40 ((yz) surface in FIGS. 1(b1)). 22 and 32 denote lead wirings. The lead wirings 22 in the x-direction are formed on the front surface of the touch panel film 40. The lead wirings 32 in the y-direction are formed on the rear surface of the touch panel film 40. 10 denotes a principal surface input region. 15a and 15b denote side surface input regions. 12 denotes a principal surface (principal surface region). 43 denotes a design print layer. 18 denotes the touch panel terminals.

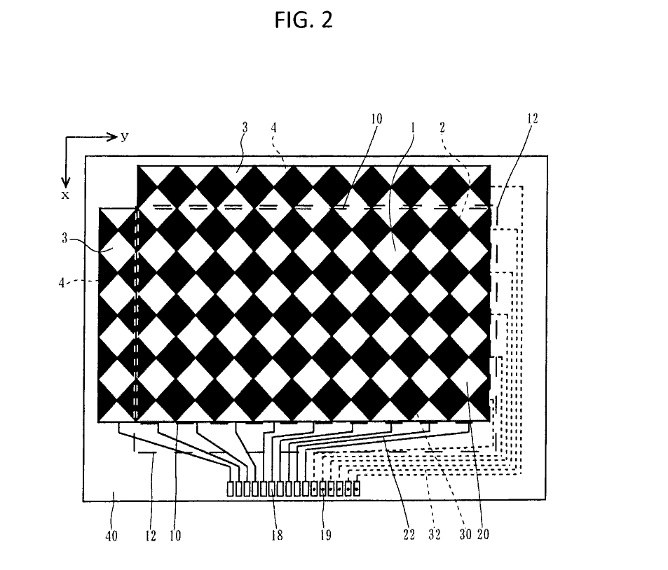

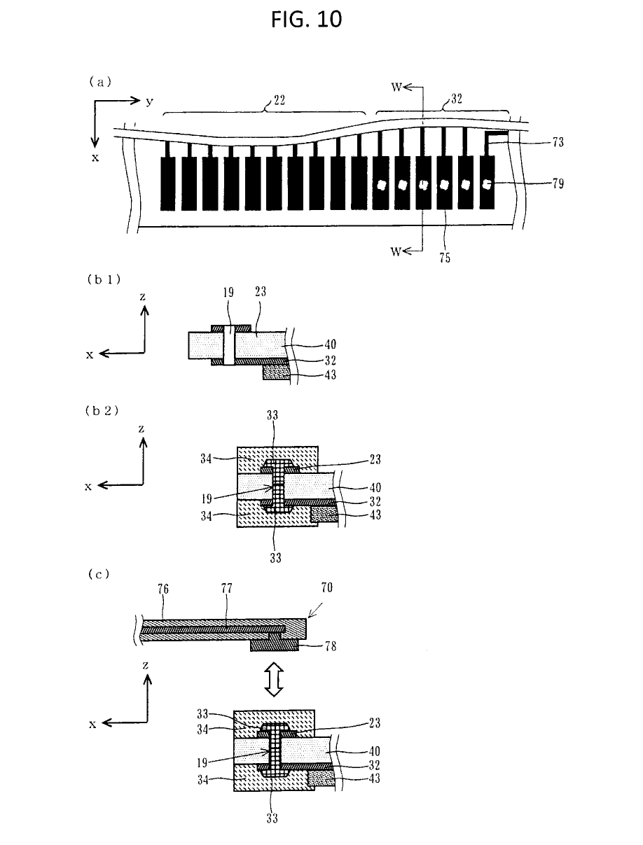

A design print layer 43 was formed on the front surface of the touch panel film 40. A touch panel film on which the island-shaped electrodes 20 and 30, the inter-electrode wirings 21 and 31, the lead wirings 22 and 32, and the design print layer 43 are formed could be obtained. The touch panel film will be described below referring to FIG. 2 to FIG. 5, and FIG. 10.

In the touch panel as a resulting product, the principal surface input region 10 and the side surface input regions 15a and 15b are illustrated with a dotted line (see, FIG. 1(a)).

The throughholes 19 may be formed in the respective touch panel terminals 18 (touch panel terminals 18 of the ends of the lead wirings 32 in the y-direction) with respect to the touch panel film on which the island-shaped electrodes 20 and 30, the inter-electrode wirings 21 and 31, the lead wirings 22 and 32, and the design print layer 43 are formed. The design print layer 43 may be formed after the throughholes 19 are formed in the touch panel terminals 18 (touch panel terminals 18 of the ends of the lead wirings 32 in the y-direction).

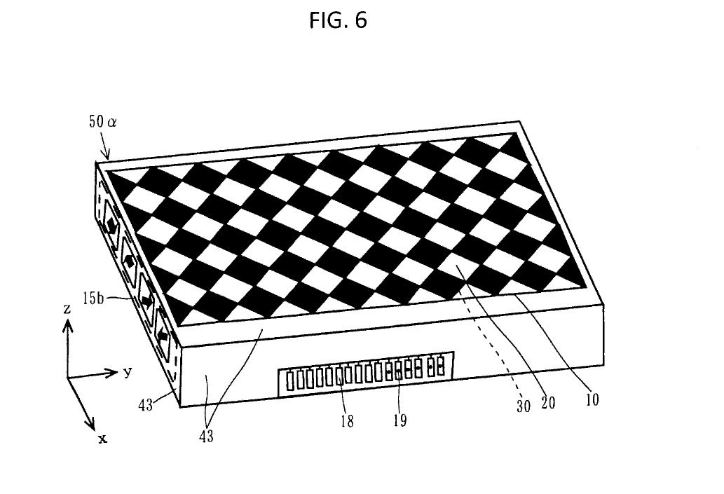

The film obtained in FIG. 1(a) was subjected to heat forming, resulting in obtainment of a touch panel film heat forming body (α) 50α (see, FIGS. 1(b1) and (b2)). The touch panel film on which net-shaped conductor patterns and the design print layer are formed (see, FIG. 1(a)) was set in a mold before being heated and softened/cooled and solidified. A target box (case) was molded by means of vacuum pressure and/or using compressed air. Then, unnecessary portions were subjected to trimming (finishing, punching). Accordingly, a box-shaped intermediate product of the film defining therein a rectangular-shaped hollow portion 63 (the touch panel heat forming body (α) with the design print layer 43 on an outside surface of the hollow portion 63) was obtained (see, FIG. 1(b1) and FIG. 1(b2)). The heat forming body (α) 50α will be described below (see, the below mentioned FIG. 6).

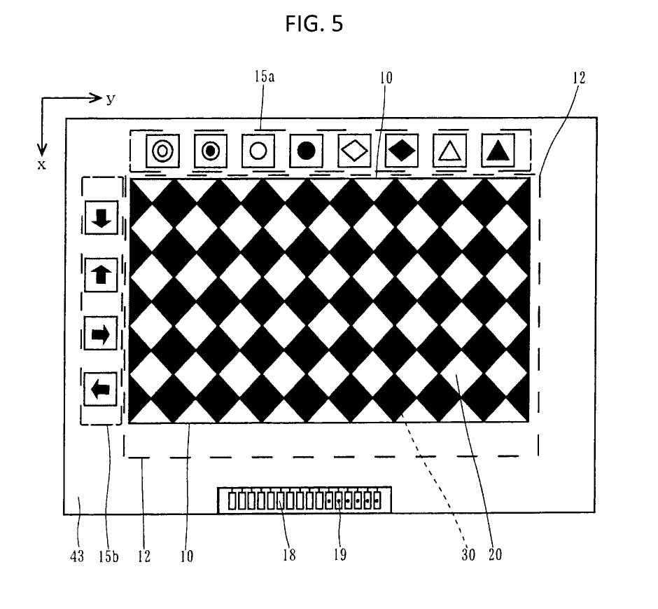

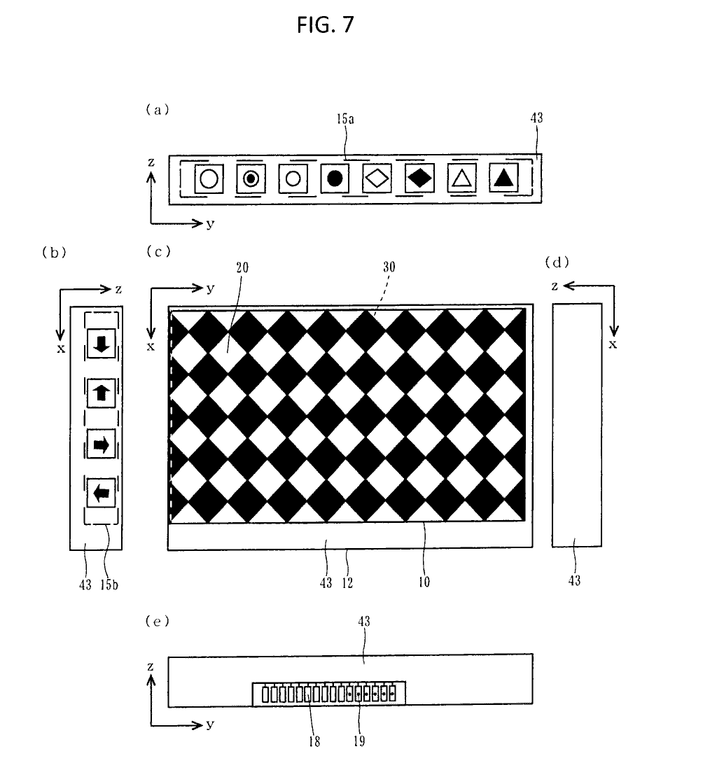

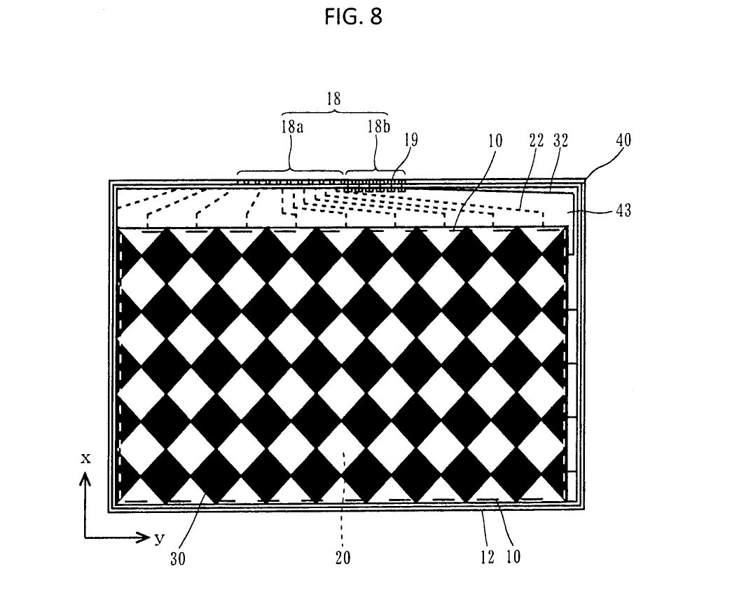

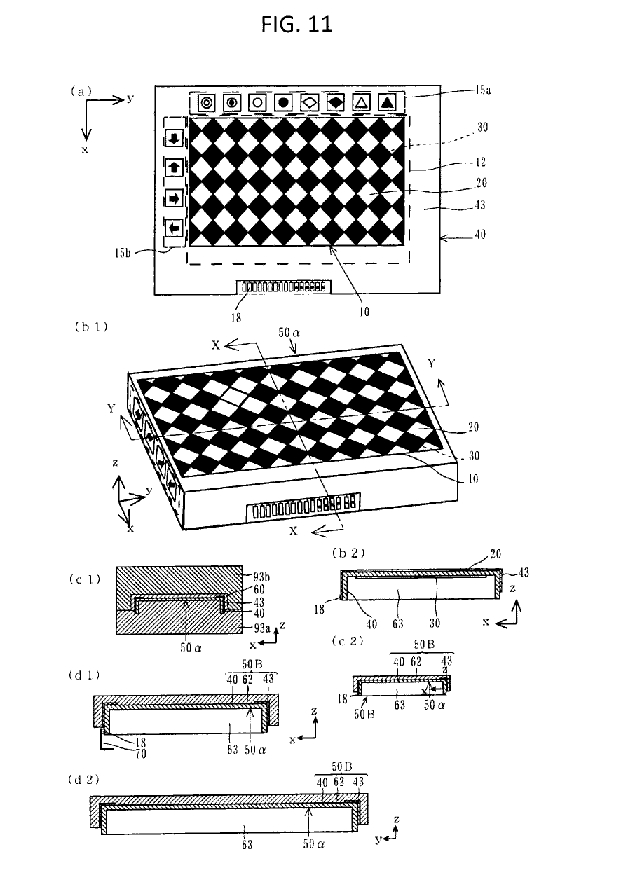

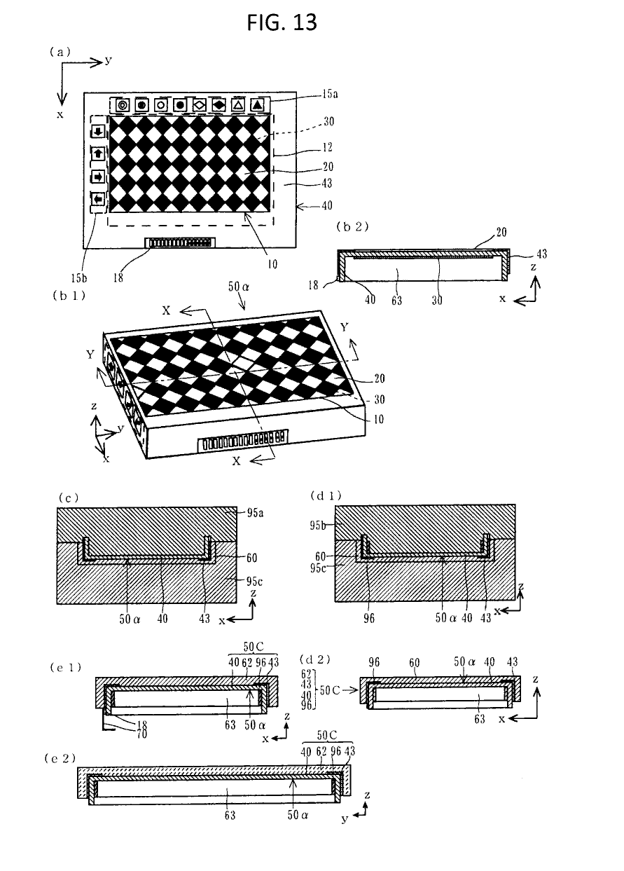

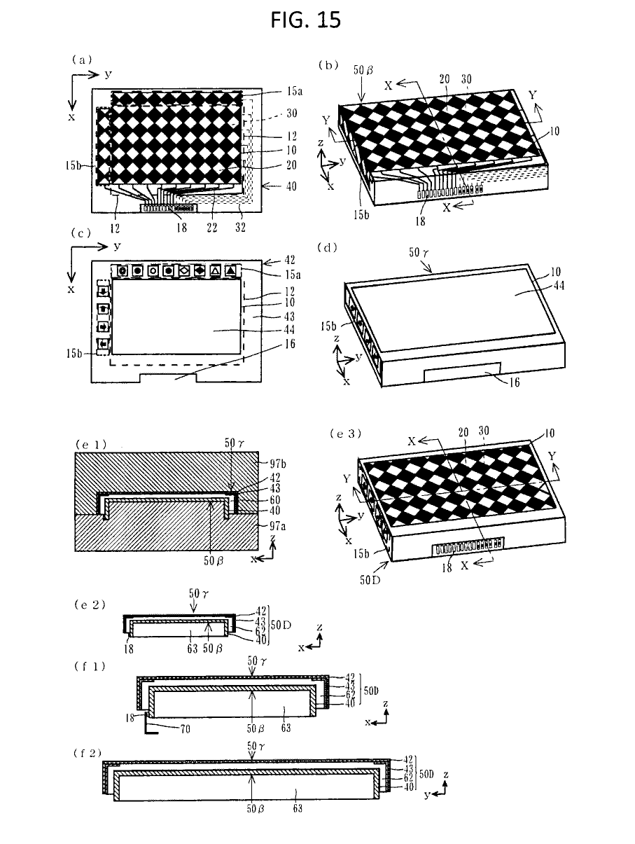

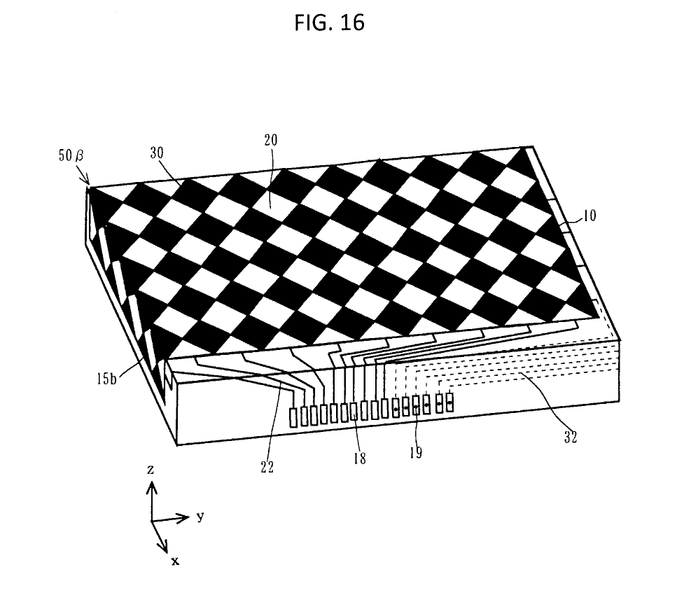

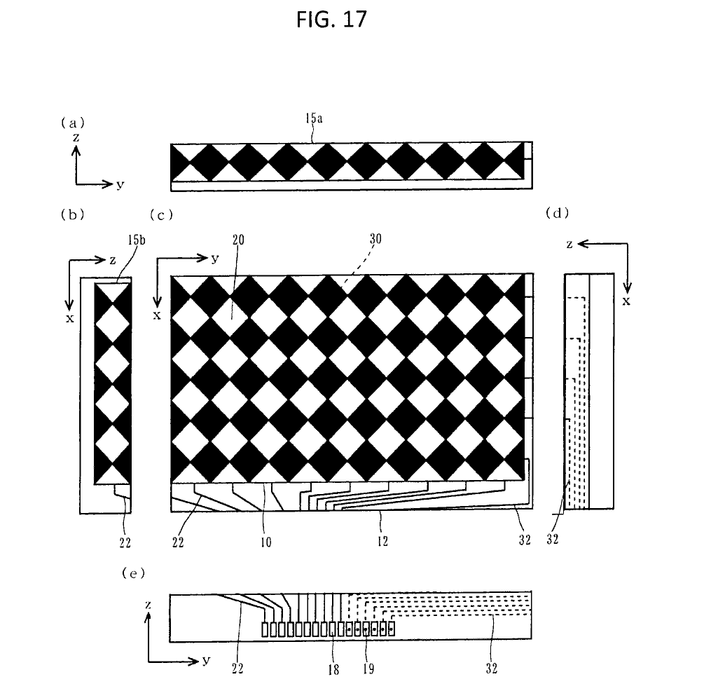

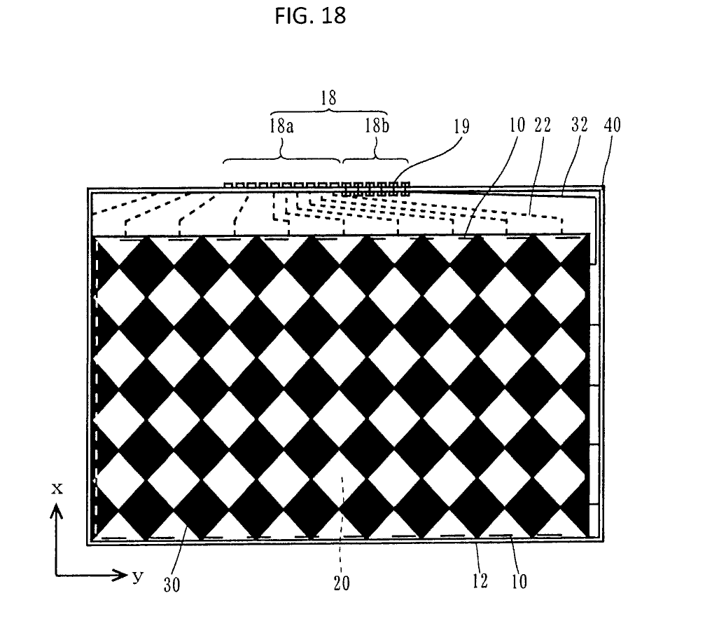

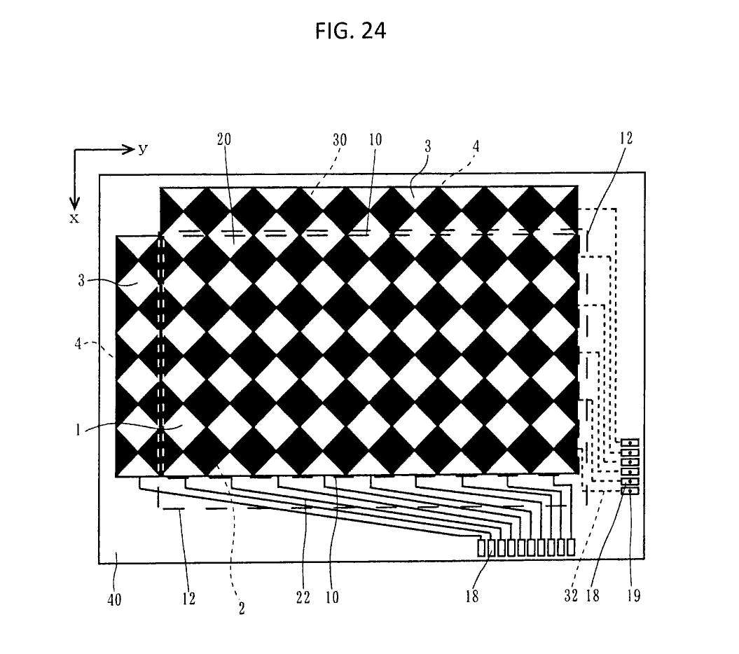

In FIG. 1(a) and FIG. 1(b), the island-shaped electrodes 20 and 30 are substantially transparent and thus are not visually recognized. However, to clarify the construction thereof, the island-shaped electrodes 20 and 30 formed on the front surface and the rear surface are illustrated with a solid line. The inter-electrode wirings 21 and 31 for establishing connection between the island-shaped electrodes are not illustrated here. When viewed from a z-direction, neighboring spaces between the island-shaped electrodes 20 on the front surface and the island-shaped electrodes 30 on the rear surface are also omitted here (This is also applied to FIG. 2, FIG. 5, FIG. 6, FIG. 7, FIG. 8, FIG. 11(a), FIG. 11(b), FIG. 13(a), FIG. 13(b), FIG. 15(a), FIG. 15(b), FIG. 15(e), FIG. 16, FIG. 17(b), FIG. 18, and FIG. 24 to FIG. 28.).

A touch panel molded body (A) 50A could be obtained by the film insert molding and the film-in-mold molding (see, FIG. 1(c) and FIG. 1(d)).

The touch panel heat forming body (α) and a releasable film 46 of which front surface was provided with a hard coat material-made temporarily harden layer 45a were subjected to the film insert molding and the film-in-mold molding. As a result, the touch panel molded body (A) 50A could be obtained.

An inner surface of the hollow portion 63 of the touch panel heat forming body (α) 50α was set over a protrusion of a protruded mold 91a. The releasable film 46 was set between an exterior surface of the touch panel heat forming body (α) 50α and a depression of a depressed mold 91b, the releasable film 46 being provided with the hard coat material-made temporarily harden layer 45a on the front surface thereof. Then, the protruded mold 91a and the depressed mold 91b were brought into die matching (mold clamping, mold closing) (see, FIG. 1(c)). A fluidized molded resin material (transparent resin 60) was injected between the hard coat material-made temporarily harden layer 45a formed on the releasable film 46 and the exterior surface of the touch panel heat forming body (α) 50α to be filled therebetween. At the same time, the temporarily harden layer 45a was transferred to the surface of the molded resin material from the surface of the releasable film 46. After cooling and solidification thereof, the mold was opened to take out a molded body from the mold.

The hard coat material-made temporarily harden layer 45a of the molded body taken out from the mold was hardened to be fully cured. The hard coat layer 45, a transparent resin case 62 made of a molded resin material, and the touch panel heat forming body (α) 50α were made into one piece. The design print layer 43 was sandwiched between the touch panel film 40 and the transparent resin case 62, resulting in obtainment of the touch panel molded body (A) 50A (see, FIG. 1(d)).

A detailed description of the mold is not illustrated in FIG. 1(c). Each of the protruded mold 91a and the depressed mold 91b is provided with a draft in order to make it easy to take out the molded body from the mold. For the purpose of releasing stress concentration and facilitating flow of the molded resin material having been heated and molten, corners (edges) are formed to have a curved surface. In the molded body, a radius of curvature (R) of each corner, the corner being formed by crossing two surfaces of a transparent resin-cured body having a thickness t, is obtained by R₁=(1/t) at an inner surface side of the corner and by R₂=(1.5/t) at an exterior surface side of the corner, respectively. For example, if t=0.5 mm, R₁=0.25 mm and R₂=0.75 mm. The drafts and the radius of curvatures (R) of the corner are provided also to projection-shaped molds 93a, 95a, 95b, and 97a and recess-shaped molds 93b, 95c, and 97b.

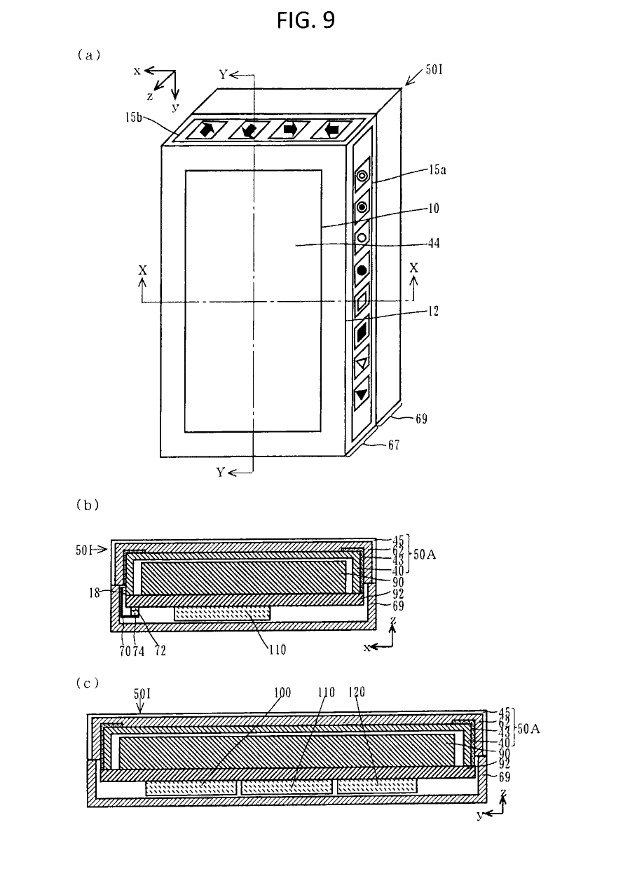

One FPC terminals of a flexible printed circuit board (FPC) 70 are connected to the touch panel terminals 18 exposing to a (zy) surface of the touch panel molded body (A) 50A (see, FIG. 1(e)). Another FPC terminals of the flexible printed circuit board (FPC) 70 are connected to a mount board with terminals 72 of a mount board 92 on which a display device 90 and a circuit such as a touch panel control/signal processing circuit 100, a display unit control/signal processing circuit 110, and an input/output integrated device control/signal processing circuit 120 are mounted (see, below mentioned FIG. 9).

A configuration of a portion in the adjacent to the touch panel terminals 18 to which the flexible printed circuit board (FPC) 70 is connected will be described below (see, FIG. 10).

(Formation of Net-Shaped Conductor Pattern on Touch Panel Film)

FIG. 2 is a plan view of a touch panel film (a) on which the island-shaped electrodes and the lead wirings are formed.

The front surface of the touch panel film 40 is provided with electrode rows of the island-shaped electrodes 20 arranged in the x-direction. The inter-electrode wirings 21 in the x-direction connect the island-shaped electrodes 20 to each other. A plurality of electrode rows (e.g., 10 rows) is formed in the y-direction. The lead wirings 22 in the x-direction are connected to the respective tail end positions of the electrode rows of the island-shaped electrodes 20.

The rear surface of the touch panel film 40 is provided with electrode rows of the island-shaped electrodes 30 arranged in the y-direction. The inter-electrode wirings 31 in the y-direction connect the island-shaped electrodes 30 to each other. A plurality of electrode rows (e.g., six rows) is formed in the x-direction. The lead wirings 32 in the y-direction are connected to the respective tail end positions of the electrode rows of the island-shaped electrodes 30.

The island-shaped electrodes 20 formed on the front surface of the touch panel film 40 and the island-shaped electrodes 30 formed on the rear surface of the touch panel film 40 do not overlap to one another when viewed from the z-direction. In other words, the island-shaped electrodes 20 and the island-shaped electrodes 30 are arranged two-dimensionally spaced to each other into a lattice shape (see, FIG. 2). Each of the island-shaped electrodes of the island-shaped electrodes 20 and 30 is formed into a diamond shape having an apex angle of 90°.

The front surface of the touch panel film 40 is provided with the touch panel terminals 18 formed thereon, the touch panel terminals 18 being connected to the lead wirings 22 in the x-direction (and the lead wirings 32 in the y-direction). The lead wirings 32 in the y-direction are connected to the touch panel terminals 18 via the throughholes 19. It is possible to form the throughholes 19 at arbitrary portions in the touch panel terminals 18 (or, at arbitrary portions around the lead wirings 32 in the y-direction on the way from the island-shaped electrodes 30 of the tail ends of the electrode rows of the island-shaped electrodes 30 arranged in the y-direction to the touch panel terminals 18).

It is possible to form the touch panel terminals 18 on the rear surface of the touch panel film 40, the touch panel terminals 18 being connected to the lead wirings 22 in the x-direction (and to the lead wirings 32 in the y-direction). It is possible to form the throughholes 19 at arbitrary portions (at arbitrary portions around the lead wirings 22 in the x-direction on the way from the island-shaped electrodes 20 of the tail ends of the electrode rows of the island-shaped electrodes 20 arranged in the x-direction to the touch panel terminals 18). The lead wirings 22 arranged in the x-direction may be connected to the touch panel terminals 18 via the throughholes 19.

Resistance values of the island-shaped electrodes (sensing electrodes) 20 and 30 and the lead wirings 22 and 32 are precisely adjusted to enhance position detection accuracy of the touched positions. As a result, a resistance adjustment unit for adjusting, as required, the resistance values of the take-out wirings 22 and 32 may be provided at an arbitrary portion (e.g., at an arbitrary portion on the way from the lead wirings 22 and 32 formed on the side surface portion of the touch panel to the touch panel terminals 18).

The principal surface input region 10 of the touch panel as a final product occupies almost all the region of the principal surface portion 12 of the film 40. The island-shaped electrodes 20 of the side surface input region 15a of the touch panel are positioned above the film 40. The island-shaped electrodes 30 of the side surface input region 15b of the touch panel are positioned left side of the film 40 (see, FIG. 2).

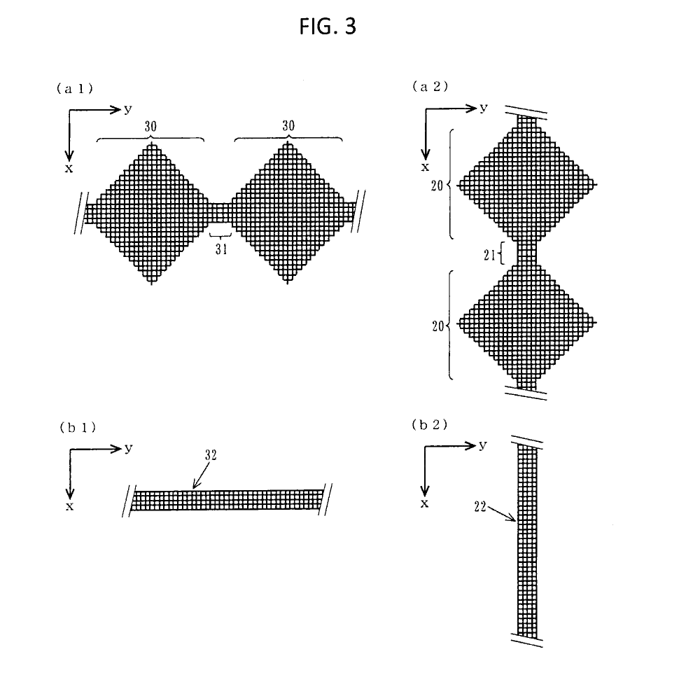

FIG. 3 is a partially enlarged plan view of the net-shaped conductors (island-shaped electrodes, inter-electrode wirings, and lead wirings). FIG. 3(a1) is an enlarged plan view illustrating an arrangement of the inter-electrode wiring 31—the island-shaped electrode 30—the inter-electrode wiring 31—the island-shaped electrode 30—the inter-electrode wiring 31 in the y-direction. FIG. 3(a2) is an enlarged plan view illustrating an arrangement of the inter-electrode wiring 21—the island-shaped electrode 20—the inter-electrode wiring 21—the island-shaped electrode 20—the inter-electrode wiring 21 in the x-direction. FIG. 3(b1) is a partially enlarged plan view of the lead wiring 32 in the y-direction. FIG. 3(b2) is a partially enlarged plan view of the lead wiring 22 in the x-direction.

The inter-electrode wirings 21 establish electrical connection between island-shaped electrodes 20. The lead wirings 22 are connected to the island-shaped electrodes 20 at their tail ends (ends) in the x-direction.

The inter-electrode wirings 31 establish electrical connection between the island-shaped electrodes 30. The lead wirings 32 are connected to the island-shaped electrodes 30 at their tail ends (ends) in the y-direction.

The island-shaped electrodes 20 and 30 and the inter-electrode wirings 21 and 31 are made of the net-shaped conductors. In the present embodiment, the lead wirings 22 and 32 are also made of the net-shaped conductors. However, it is not essential that the lead wirings 22 and 32 are formed into the net-shape. The lead wirings 22 and 32 may be formed into a solid wiring.

The touch panel terminals 18 as extensions of the lead wirings 22 and 32 may be formed into the net-shape or may not be formed into the net-shape.

Preferably, the island-shaped electrodes and the inter-electrode wirings are formed into the net shape in view of the light transmittance. Specifically, the island-shaped electrodes and the inter-electrode wirings are preferably formed into the net shape of the aperture ratio equal to or more than 90%. As a result, the thin lines are hardly visually recognized, and the display screen becomes visually bright.

The island-shaped electrodes 20 and 30, the inter-electrode wirings 21 and 31, and the lead wirings 22 and 32 are preferably made of the net-shaped conductors. This is because the electrical disconnection hardly occurred in the net-shaped conductors during the molding of the film into a case (box shape). The heat forming bodies (α) and (β) are obtainable by subjecting the touch panel film to the heat forming, the touch panel film being provided with the island-shaped electrodes, the inter-electrode wirings, and the lead wirings formed thereon. At the time, even when the net-shaped conductors (the island-shaped electrodes, the inter-electrode wirings, and the lead wirings) were positioned at the corner (ridgeline portion) of the heat forming body as well as even when a tensile force and a compressive force that occurred during the heat forming process affected on the net-shaped conductors, the electrical disconnection hardly occurred for the net-shaped conductors. Specifically, in a case where the net-shaped conductors were made of, for example, Au, Ag, Cu, and Al, the electrical disconnection hardly occurred.

In a case where the lead wirings are solid wirings, it is preferable that the lead wirings are made of, for example, Au, Ag, Cu, and Al. It is because the Au, Ag, Cu, and Al are excellent in malleability and ductility. This minimizes occurrence of the electrical disconnection.

The net-shaped conductor is capable of being formed by any one of the above described methods [e.g., (1) method by printing of conductive ink, (2) method by etching a conductive thin film, (3) metal deposition method using a deposition mask, and (4) conductive silver forming method using silver salt)].

(Formation of Design Print Layer on Touch Panel Film)

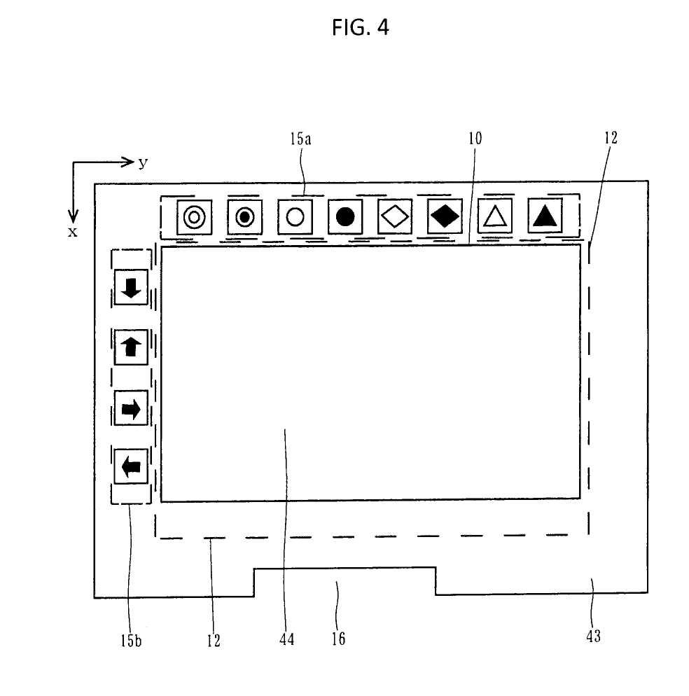

FIG. 4 is a plan view of a design print layer to be formed on the touch panel film.

The principal surface input region 10 that occupies almost all the range of the region 12 as the principle surface ((xy) surface) of the touch panel is formed into a light permeable transparent opening region 44. The region is a part where a design print layer 43 is not formed. An outer peripheral portion of the opening region 44 is provided with the design print layer formed thereon (see, FIG. 4).

For example, guidance keys 7 and a transparent background are formed on portions that are formed into the side surface input regions 15a and 15b (portions indicated by a dotted line) by printing in order allow the guidance keys 7 to carry out various operations. A region (lower right region of FIG. 4) that is the outer peripheral portion of the opening region 44 and is not the side surface input region is provided with a non-light transmissive layer printed thereon as the design print layer 43 (see, FIG. 4).

A touch panel terminal opening portion 16 is an opening portion (see, FIG. 4). The touch panel terminals 18 (see, FIG. 5) expose from the opening 16. The design print layer is not provided on the opening 16 (see, FIG. 4).

FIG. 5 is a plan view of a touch panel film (a). The touch panel film (a) is provided with the island-shaped electrodes, the lead wirings, and the design print layer formed thereon. FIG. 5 has such a structure that FIG. 4 overlaps FIG. 2. Therefore, a description of FIG. 5 is omitted here.

(Formation of Touch Panel Film Heat Forming Body (α))

FIG. 6 is a perspective view of a touch panel film heat forming body (α).

The touch panel heat forming body (α) 50α includes therein a rectangular-shaped hollow portion 63. The design print layer is provided on each of a principal surface and side surfaces of the touch panel heat forming body (α) 50α. The principal surface input region (on which the island-shaped electrodes 20 arranged in the x-direction and the island-shaped electrodes 30 arranged in the y-direction are formed) 10 is formed on the principal surface portion ((xy) surface) 12 of the touch panel heat forming body (α) 50α. The design print layer 43 is formed on an outer peripheral region of the principal surface input region 10. The side surface input regions 15a and 15b are formed on side surfaces orthogonal to the principal surface ((xy) surface). The design print layer 43 is formed on the outer peripheral regions of the side surface input regions 15a and 15b. The touch panel terminals 18 and the touch panel terminal opening portion 16 are formed on the side surface. The throughholes 19 are formed in the touch panel terminal opening portion 16 (see, FIG. 6).

FIG. 7 includes illustrative drawings illustrating the touch panel film heat forming body (α). FIG. 7(a) is a rear surface view thereof. FIG. 7(b) is a left-side surface view thereof. FIG. 7(c) is a plan view thereof. FIG. 7(d) is a right-side surface view thereof. FIG. 7(e) is a front surface view thereof.

The touch panel heat forming body (α) 50α includes the principal surface portion 12 ((xy) surface). The principal surface input region 10 is formed on the principal surface portion 12. The principal surface input region 10 occupies almost all the region of the principal surface portion 12. The side surface input region 15a is formed on the rear surface (side surface) thereof. The side surface input region 15b is formed on the left-side surface thereof. The touch panel terminals 18 and the touch panel terminal opening portion 16 are formed on the front surface (side surface). The throughholes 19 are formed in the touch panel terminal opening portion 16. The design print layer 43 is formed in order to shield the lead wirings 22 in the x-direction and the lead wirings 32 in the y-direction. The design print layer 43 is formed on the right-side surface in order to shield the lead wirings 32 in the y-direction (see, FIG. 7).

FIG. 8 is a bottom surface view of the touch panel film heat forming body (α).

The lead wirings 22 in the x-direction are connected to the terminals 18a. The lead wirings 22 are connected to ends of the electrode rows (6^{th} rows) of the island-shaped electrodes 20 arranged in the x-direction. The lead wirings 22 are formed on the front surface of the touch panel heat forming body (α) 50α. The lead wirings 32 in the y-direction are connected to the terminals 18b. The lead wirings 32 are connected to ends of the electrode rows (10^{th} rows) of the island-shaped electrodes 30 arranged in the y-direction. The lead wirings 32 are formed on the right-side surface of the touch panel heat forming body (α) 50α (see, FIG. 8).

<Input/Output Integrated Device (I)>

An input/output integrated device (I) (including a touch panel (touch panel molded body (A)) and a display device) will be described below.

FIG. 9 includes illustrative drawings illustrating the input/output integrated device (I). FIG. 9(a) is a perspective view thereof (without illustrating the hard coat layer). FIG. 9(b) is a cross sectional view thereof taken along the line X-X. FIG. 9(c) is a cross sectional view thereof taken along the line Y-Y.

An input/output integrated device (I) 50I includes an upper box body 67 constituted of the touch panel molded body (A) 50A and a lower box body 69 to be mated with the upper box body 67. The upper box body 67 and the lower box body 69 define a confined space therein (see, FIG. 9).

The hard coat layer 45 that is the outermost layer of the touch panel molded body (A) 50A is not illustrated here (see, FIG. 9(a)). The opening region 44 is a transparent region of a touch panel film 40 with no design print layer thereon. The opening region 44 corresponds to the principal surface input region 10. The island-shaped electrodes 20 and 30 are not illustrated.

A display device 90 mounted to one surface of the mount board with terminals 72 is accommodated in an inner space of the upper box body 67 (see, FIG. 9(b) and FIG. 9(c)). The upper box body 67 and the mount board with terminals 72 are coupled to each other. The other surface of the mount board with terminals 72 is provided with the circuit such as the touch panel control/signal processing circuit 100, the display unit control/signal processing circuit 110, and the input/output integrated device control/signal processing circuit 120.

One FPAC terminal block (a terminal block of the flexible printed circuit board (FPC) 70) is connected to the touch panel terminals 18. The other FPAC terminal block is coupled to the mount board with terminals 72 of the mount board 92. The mount board with terminals 72 is electrically coupled to the touch panel terminals 18 via the flexible printed circuit board (FPC) 70.

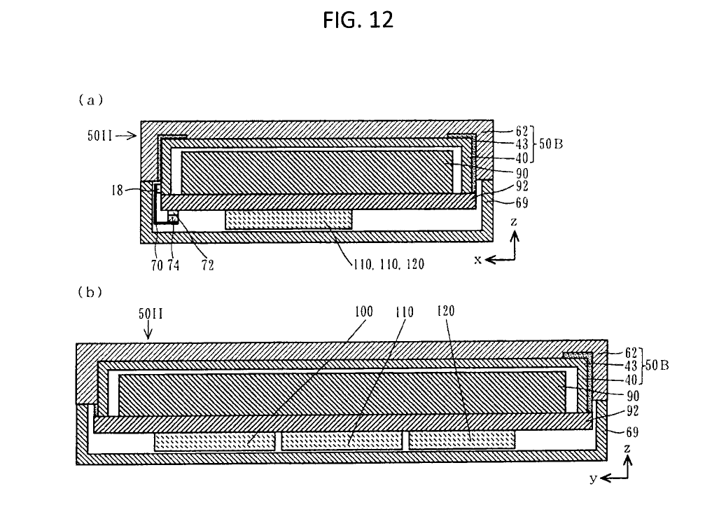

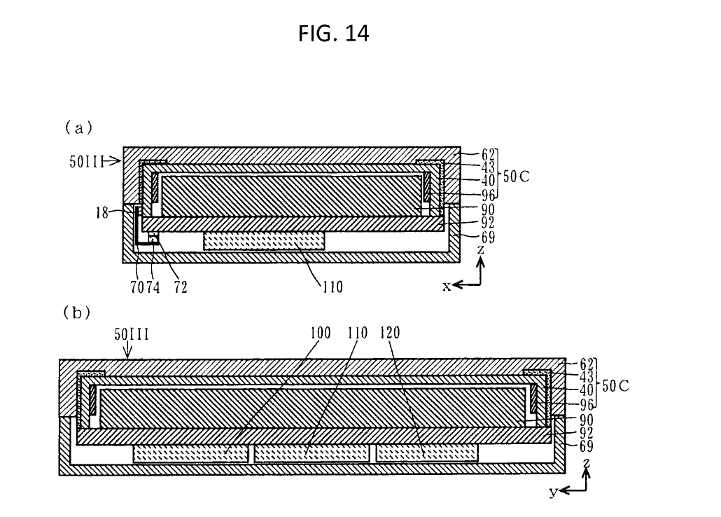

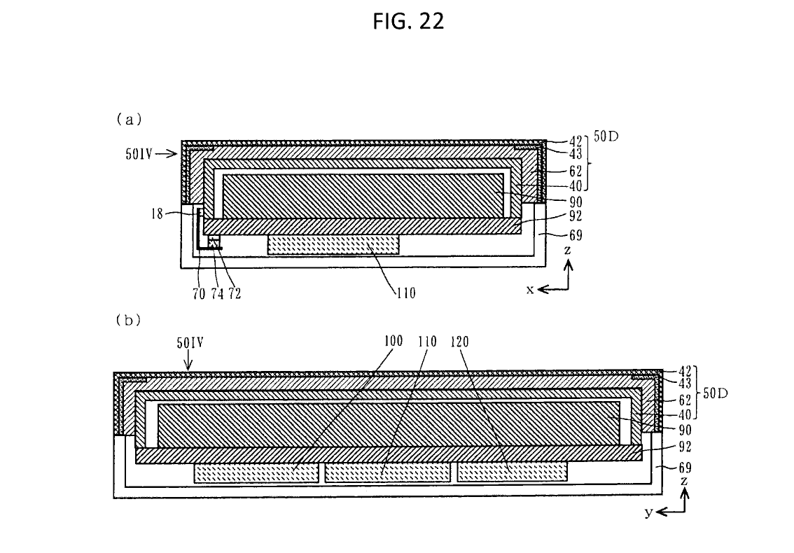

Signal transmission is performed via common external circuits 100, 110, and 120 with respect to the electrode rows formed on the principal surface input region and the side surface input regions (This is also applied to the below mentioned FIG. 12, FIG. 14, and FIG. 22).

The one FPAC terminal block and the touch panel terminals 18 are bonded by, for example, anisotropic conducting adhesive. The other FPAC terminal block and the mount board with terminals 72 are bonded by, for example, anisotropic conducting adhesive.

The one FPAC terminal block and the other FPAC terminal block are bonded to the touch panel terminals 18 and the mount board with terminals 72, respectively, by anisotropic conducting adhesive (see, FIG. 9(b)). How the one FPAC terminal block is bonded to the touch panel terminals 18 is not illustrated in detail (This is also applied to FIG. 12, FIG. 14, and FIG. 22).

Examples of anisotropic conducting adhesive include an Anisotropic Conductive Film (ACF) and an Anisotropic Conductive Paste (ACP) which are available in market. For example, the Anisotropic Conductive Film is interposed between the mount board with terminals 72 and the other FPAC terminal block. Alternatively, after the Anisotropic Conductive Paste is applied to either one of the mount board with terminals 72 and the other FPAC terminal block, the anisotropic conducting adhesive is hardened by applying pressure thereto. The mount board with terminals 72 is electrically connected to the other FPAC terminal block as well as the mount board 92 is coupled to the flexible printed circuit board (FPC) 70.

FIG. 10 includes illustrative drawings illustrating the touch panel terminals. FIG. 10(a) is an enlarged plan view illustrating the touch panel terminals. FIG. 10(b) is an enlarged cross sectional view thereof taken along the line W-W. FIG. 10(b1) is a cross sectional view at a time when a throughhole is formed. FIG. 10(b2) is a cross sectional view after the protective layer is formed. FIG. 10(c) is an illustrative drawing illustrating a positional relationship between the touch panel terminal and the FPC terminal block.

The protective layers 34 are formed. The protective layers 34 cover exposed portions that are not covered with the design print layer 43 and a portion of the isolated wiring 23. The exposed portions are exposed portions in the adjacent to the touch panel terminal 18. The exposed portions are conductors exposing to the outside, the conductors being filled into the throughholes 19. The lead wirings 73 and the touch panel terminals 75 are covered with the protective layers 34 (see, FIG. 10). This is also applied to the touch panel terminals 18 illustrated in the below mentioned FIG. 11, FIG. 13, FIG. 15 to FIG. 18, and FIG. 24 to FIG. 28.

The touch panel terminals 18 are extensions of the lead wirings 32. Therefore, the touch panel terminal 18 is illustrated as a cross section of the lead wiring 32. The isolated wirings 23 are formed on a surface on which the lead wirings 22 are formed. The isolated wirings 23 are not connected to the lead wirings 22. The isolated wirings 23 are connected to the lead wirings 32 via the conductors filled in the throughholes 19 (see, FIG. 10(b) and FIG. 10(c)).

The throughholes 19 are formed after the island-shaped electrodes 20 and 30, the lead wirings 22 and 32, and the touch panel terminals 18 are formed on the touch panel film 40. The throughholes 19 are used for establishing electrical connection between the isolated wirings 23 and the lead wirings 32 (see, FIG. 10(b1)).

The isolated wirings 23 may be formed into the net-shaped conductors or the solid wirings similar to the cases of the lead wirings 22 and 32 and the touch panel terminals 18.

The touch panel terminals 18 and the throughholes 19 may be formed after the island-shaped electrodes 20 and 30, the inter-electrode wirings 21 and 31, the lead wirings 22 and 32, and the design print layer 43 are formed on the touch panel film 40. The design print layer 43 may be formed after the touch panel terminals 18 and the throughholes 19 are formed.

In cases where carbon ink is supplied and filled into the throughholes 19 from both surface sides of the touch panel film 40 and where the design layer printed layer 43 is formed, the protective layers 34 are provided. The protective layers 34 completely cover portions that are not covered with the design layer printed layer 43, the portions including the isolated wirings 23, the lead wirings 32, and the surface exposing carbon 33 after being filled into the throughholes 19. The protective layers are formed by printing carbon ink (see, FIG. 10(b2)).

When the lead wirings 22 and 32 and the touch panel terminals 18 are made of Ag, the carbon protective layers 34 completely cover the portion made of Ag. This prevents the Ag from being oxidized and migrated.

In a case where the design layer printed layer 43 is formed after the protective layers 34 are provided, the design layer printed layer 43 is provided so as to overlap the protective layers 34.

FIG. 10(c) and FIG. 9(b) are related to each other. FIG. 10(c) illustrates a positional relationship between the touch panel terminals 18 and the FPAC terminal block 78 when they are connected to each other. The anisotropic conducting adhesive contributes to establishment of electrical connection between the carbon protective layers 34 formed over the touch panel terminals 18 and the FPAC terminal block 78.

<Input/Output Integrated Device (II) (Including Touch Panel Constituted of Touch Panel Molded Body (B) and Display Device)>

<Touch Panel Molded Body (B)>

A touch panel molded body (B) is manufactured by the following manufacturing processes (see, FIG. 11).

FIG. 11 includes illustrative drawings illustrating processes of manufacturing the touch panel molded body (B). FIG. 11(a) is a plan view of a film obtained through a process of forming the island-shaped electrodes and the lead wirings on the touch panel film and a process of forming the design print layer. FIG. 11(b1) is a perspective view of the touch panel film heat forming body (α) obtained via a process of heat-forming the film of FIG. 11(a). FIG. 11(b2) is a cross sectional view thereof taken along the line X-X of FIG. 11(b1). FIG. 11(c) is a cross sectional view thereof taken along the line X-X in the process of film insert-molding. FIG. 11(d1) is a cross sectional view of the touch panel molded body (B) coupled to the flexible printed circuit board (FPC) taken along the line X-X. FIG. 11(d2) is a cross sectional view thereof taken along the line Y-Y.

The touch panel molded body (A) of FIG. 1 is provided with the hard coat layer 45. The touch panel molded body (B) of FIG. 11 is not provided with the hard coat layer 45.

FIG. 11(a) and FIG. 11(b) are similar to FIG. 1(a) and FIG. 1(b), respectively. The present embodiment was carried out in a manner similar to FIG. 1(a) and FIG. 1(b). Initially, the net-shaped conductor patterns 20, 30, and 18 were formed on the touch panel film 40. Next, the design print layer 43 was formed thereon. As a result, a touch panel film on which the net-shaped conductor patterns 20, 30, and 18 and the design print layer 43 were formed was produced. The resulting touch panel film was subjected to the heat forming. As a result, the touch panel heat forming body (α) 50α was obtained.

The film insert molding was carried out with respect to the touch panel heat forming body (α) 50α, resulting in obtainment of the touch panel molded body (B) (see, FIG. 11(c)). That is, an interior surface of the hollow portion 63 of the touch panel heat forming body (α) 50α was set onto a protrusion of a projection-shaped mold 93a. The projection-shaped mold 93a and a recess-shaped mold 93b were subjected to die matching (mold clamping, mold closing). The fluidized molded resin material (transparent resin 60) was injected into a space between the depression of the recess-shaped mold 93b and the exterior surface of the touch panel heat forming body (α) 50α to be filled therebetween. After cooling and solidification thereof, the mold was opened. A molded body (B) 50B was taken out from the mold.

The touch panel molded body (B) 50B is a result of an integration of the transparent resin case 62 and the touch panel heat forming body (α) 50α. The design print layer 43 is sandwiched between the touch panel film 40 and the transparent resin case 62. The design print layer 43 is completely sealed therebetween.

FIG. 11(d) illustrates a case that the touch panel molded body (A) 50A is substituted by a touch panel molded body (B) 50B (see, FIG. 1(e)). Therefore, a detailed description thereof is omitted here.

<Input/Output Integrated Device (II)>

An input/output integrated device (II) (including the touch panel constituted of the touch panel molded body (b) and the display device) will be described below.

FIG. 12 includes illustrative drawings illustrating the input/output integrated device (II). FIG. 12(a) is a cross sectional view thereof taken along the line X-X (the same position as the position indicated by the above described X-X). FIG. 12(b) is a cross sectional view thereof taken along the line Y-Y (the same position as the position indicated by the above described Y-Y).

The input/output integrated device (II) 50II of FIG. 12 is similar to the input/output integrated device (I) 50I of FIG. 9. FIG. 12 illustrates such a case that the touch panel molded body (A) 50A is substituted by the touch panel molded body (B) 50B (see, FIG. 1). Therefore, a detailed description thereof will be omitted here.

<Input/Output Integrated Device (III) (Including Touch Panel Constituted of Touch Panel Molded Body (C) and Display Device)>

<Touch Panel Molded Body (C)>

The touch panel molded body (C) is manufactured through the below described manufacturing processes (see, FIG. 13).

FIG. 13 includes illustrative drawings illustrating processes of manufacturing the touch panel molded body (C). FIG. 13(a) is a plan view of a film manufactured through a process of forming the island-shaped electrodes and the lead wirings on the touch panel film and a process of forming the design print layer. FIG. 13(b1) is a perspective view of the touch panel film heat forming body (α) obtained through a process of heat-forming the film of FIG. 13(a). FIG. 13(b2) is a cross sectional view of the touch panel film heat forming body (α) of FIG. 13(b1) taken along the line X-X. FIG. 13(c) is a cross sectional view thereof taken along the line X-X in a process of insert-molding the film. FIG. 13(d1) and FIG. 13(d2) are cross sectional views in a process of molding the reinforcing material. FIG. 13(e1) is a cross sectional view of the touch panel molded body (B) coupled to the flexible printed circuit board (FPC) taken along the line X-X. FIG. 13(e2) is a cross sectional view of the touch panel molded body (B) coupled to the flexible printed circuit board (FPC) taken along the line Y-Y.

The touch panel molded body (C) 50C includes a reinforcing frame 96. However, the touch panel molded body (B) 50B does not include the reinforcing frame 96.

FIG. 13(a) and FIG. 13(b) are similar to FIG. 1(a) and FIG. 1(b), respectively. The touch panel molded body (C) 50C is obtainable in a manner similar to the case of the touch panel molded body (B) 50B. Initially, the net-shaped conductor patterns 20, 30, and 18 were formed on the touch panel film 40. Next, the design print layer 43 was formed thereon. A touch panel film on which the net-shaped conductor patterns 20, 30, and 18 and the design print layer 43 were formed was obtained. The resulting film was subjected to the heat forming. As a result, the touch panel heat forming body (α) 50α was obtained.

Film insert molding (primary molding) was carried out using the touch panel heat forming body (α) 50α. Subsequently, reinforcing material molding (secondary molding) was carried out. The touch panel molded body (C) 50C was obtained by the above described two step molding. In the two step molding (primary molding, secondary molding), a recess-shaped mold 95c is commonly used.

Initially, the inner surface of the hollow portion 63 of the touch panel heat forming body (a) 50α was set onto a protrusion of a projection-shaped mold 95a (see, FIG. 13(c)). The exterior surface of the hollow portion 63 of the touch panel heat forming body (α) 50α was set onto a depression of the recess-shaped mold 95c. Die matching was carried out between the projection-shaped mold 95a and the recess-shaped mold 95c.

The fluidized molded resin material (transparent resin 60) was injected into a space between the depression of the recess-shaped mold 95c and the exterior surface of the touch panel heat forming body (α) 50α to be filled therebetween. A primary molded body was obtained by cooling and solidification (primary molding).

Then, the mold was opened. While the primary molded body was left in the recess-shaped mold 95c, the projection-shaped mold 95a was changed to a projection-shaped mold 95b. Secondary molding was carried out. The reinforcing frame 96 was formed on the inner surface of the hollow portion 63 of the transparent resin 60 having been cooled and solidified during the primary molding (see, FIG. 13(d)).

In the secondary molding, the projection-shaped mold 95b was set in the hollow portion 63 of the transparent resin 60 having been cooled and solidified during the primary molding. Die matching was carried out between the recess-shaped mold 95c and the projection-shaped mold 95b. The fluidized molded resin material was injected into a space between a side surface of the protrusion of the projection-shaped mold 95b and an inner side surface of the touch panel heat forming body (α) 50α to be filled therebetween. A secondary molded body was obtained by cooling and solidification thereof (secondary molding).

Alternatively, in the secondary molding, the reinforcing frame 96 in the temporarily hardened state (e.g., thermosetting resin at stage B) was set in the hollow portion 63 of the transparent resin 60 having been cooled and solidified in the primary molding. The protrusion of the projection-shaped mold 95b was set in a frame of the reinforcing frame 96. The reinforcing frame 96 in the temporarily hardened state is sandwiched between the transparent resin 60 and the protrusion of the projection-shaped mold 95b that were cooled and solidified in the primary molding. The temporarily hardened reinforcing frame 96 was hardened to be fully cured by heating. As a result, it was also possible to obtain the secondary molded body.

Alternatively, the reinforcing frame 96 in the temporarily hardened state was set on an exterior surface of the protrusion of the projection-shaped mold 95b in the secondary molding. The protrusion of the projection-shaped mold 95b was set in the hollow portion 63 of the transparent resin 60 that was cooled and solidified in the primary molding. The reinforcing frame 96 in the temporarily hardened state is sandwiched between the transparent resin 60 and the protrusion of the projection-shaped mold 95b. In this state, the reinforcing frame 96 in the temporarily hardened state was heated and hardened to be fully cured. Accordingly, it was also possible to obtain the secondary molded body.

The molded resin material in the secondary molding differs from the molded resin material (transparent resin 60) in the primary molding. For example, the molded resin is a molding resin material that is filled with inorganic particles in order to enhance strength. The molding resin material is not necessarily transparent. For example, the molding resin material is a thermosetting resin filled with inorganic particles (e.g., epoxy resin, unsaturated polyester resin, phenol resin, urea resin, polyurethane resin, and silicone resin).

As a result, the touch panel molded body (C) 50C was obtained. The touch panel molded body (C) 50C includes the reinforcing frame 96, the transparent resin case 62, and the touch panel heat forming body (α). The above three components are integrated. The design print layer 43 is sandwiched between the touch panel film 40 and the transparent resin case 62. The design print layer 43 is completely sealed therebetween.

The touch panel molded body (A) 50A is similar to the touch panel molded body (C) 50C (see, FIG. 13(e) and FIG. 1(e)). Therefore, a description thereof is omitted here.

<Input/Output Integrated Device (III)>

An input/output integrated device (III) (including the touch panel constituted of the touch panel molded body (c) and the display device) will be described below.

FIG. 14 includes illustrative drawings illustrating the input/output integrated device (III). FIG. 14(a) is a cross sectional view thereof taken along the line X-X (a position identical to the position taken along the above described line X-X). FIG. 14(b) is a cross sectional view thereof taken along the line Y-Y (a position identical to the position taken along the above described line Y-Y).

The input/output integrated device (III) 50III of FIG. 14 is similar to the input/output integrated device (I) 50I of FIG. 9. FIG. 14 illustrates such a case that the touch panel molded body (A) 50A is substituted by the touch panel molded body (C) 50C (see, FIG. 1). Therefore, a description thereof will be omitted here.

<Input/Output Integrated Device (IV) (Including Touch Panel Constituted of Touch Panel Molded Body (D) and Display Device)>

<Touch Panel Molded Body (D)>

A touch panel molded body (D) is manufactured through the below mentioned manufacturing processes (see, FIG. 15).

FIG. 15 includes illustrative drawings illustrating processes of manufacturing the touch panel molded body (D). FIG. 15(a) is a plan view of a film obtained through a process of forming the island-shaped electrodes and the lead wirings on a touch panel film. FIG. 15(b) is a perspective view of a touch panel film heat forming body (β) manufactured in such a manner that the film of FIG. 15(a) is subjected to heat forming. FIG. 15(c) is a plan view of the design film on which the design print layer is formed. FIG. 15(d) is a perspective view of a design film heat forming body manufactured in such a manner that the design film of FIG. 15(c) is subjected to heat forming. FIG. 15(e1) is a cross sectional view thereof in the film insert-molding process. FIG. 15 (e2) is a perspective view of the touch panel molded body (D). FIG. 15(e3) is a cross sectional view thereof taken along the line X-X. FIG. 15(f1) is a cross sectional view of the touch panel molded body (D) coupled to the flexible printed circuit board (FPC) taken along the line X-X. FIG. 15(f2) is a cross sectional view of the touch panel molded body (D) coupled to the flexible printed circuit board (FPC) taken along the line Y-Y.

A net-shaped conductor pattern similar to that of FIG. 1(a) was formed on the touch panel film 40 (see, FIG. 15(a)). The touch panel film 40 on which the net-shaped conductor pattern was formed was set in a mold before being subjected to heating and softening and/or cooling and solidification. The touch panel film 40 was molded to be formed into a case (box) shape by vacuum pressure and/or using compressed air. Subsequently, unwanted portion was trimmed (was subjected to finishing or punching). As a result, the touch panel heat forming body (β) 50β was obtained (see, FIG. 15(b)). The touch panel heat forming body (β) 50β has a hollow portion of a rectangular shape therein.

The design print layer 43 similar to that of FIG. 1(a) was formed on a design film 42 (see, FIG. 15(c)). The design film 42 on which the design print layer 43 was formed was set in a mold before being subjected to the heating and softening and/or cooling and solidification. The design film 42 was molded to be a case (box) shape by vacuum pressure and/or using compressed air. Subsequently, unwanted portion was trimmed (subjected to finishing or punching). As a result, a design film heat forming body (γ) 50γ was obtained (see, FIG. 15(d)). The design film heat forming body (γ) 50γ has a rectangular-shaped hollow portion therein.

A touch panel molded body (D) 50D was obtained by double film insert molding using the touch panel heat forming body (β) 50β and the design film heat forming body (γ) 50γ (see, FIG. 15(e)). The touch panel molded body (D) 50D has the hollow portion 63 therein.

An inner surface of the hollow portion of the touch panel heat forming body (β) 50β was set onto a protrusion of a projection-shaped mold 97a. An exterior surface of the hollow portion of the heat forming body (γ) 50γ was set onto a depression of a recess-shaped mold 97b. Die matching was carried out between the projection-shaped mold 97a and the recess-shaped mold 97b. The fluidized molded resin material (transparent resin 60) was injected into a space between an exterior surface of the touch panel heat forming body (β) 50β and an inner surface of the design film heat forming body (γ) 50γ to be filled therebetween. After cooling and solidification thereof, the mold was opened. As a result, the touch panel molded body (D) 50D was obtained (see, FIG. 15(e)). The touch panel molded body (D) SOD has the hollow portion 63 therein.

The touch panel molded body (D) 50D is an integration of the transparent resin case 62, the touch panel heat forming body (β) 50β, and the design film heat forming body (γ) 50γ. The design print layer is sandwiched between the design film and the transparent resin case 62. The design print layer is completely sealed therebetween.

The touch panel molded body (A) 50A is similar to the touch panel molded body (D) 50D (see, FIG. 15(f) and FIG. 1(e)). Therefore, a description thereof is omitted here.

FIG. 16 is a perspective view of the touch panel film heat forming body (β). FIG. 17 includes illustrative drawings illustrating the touch panel film heat forming body (p). FIG. 17(a) is a rear surface view thereof. FIG. 17(b) is a left-side surface view thereof. FIG. 17(c) is a plan view thereof. FIG. 17 (d) is a right-side surface view thereof. FIG. 17(e) is a front surface view thereof. FIG. 18 is a bottom surface view of the touch panel film heat forming body (β).

The touch panel film heat forming body (α) 50α of FIG. 6 includes the design print layer 43. The touch panel film heat forming body (β) 50β of the present embodiment is an exemplary touch panel film heat forming body in which the design print layer 43 was not provided. That is, the touch panel film heat forming body (β) 50β of the present embodiment does not include the design print layer. Therefore, a description thereof is omitted here.

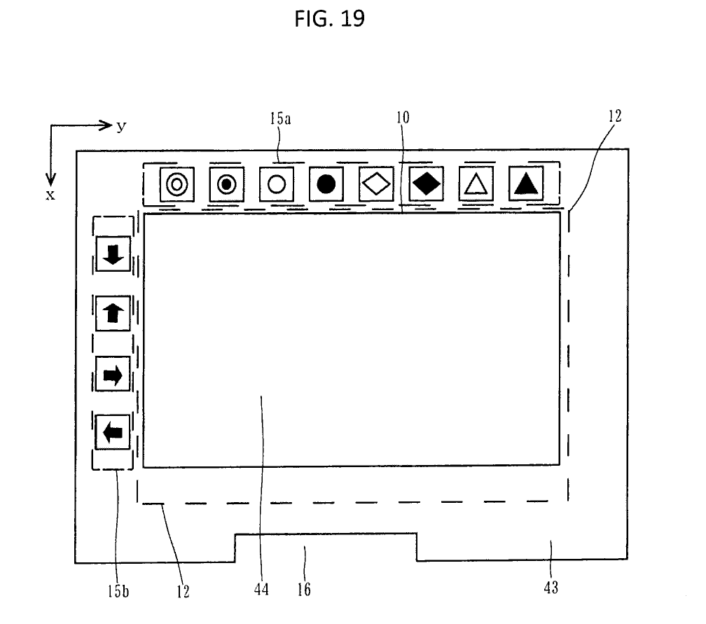

FIG. 19 is a plan view of a design film.

The design print layer 43 (see, FIG. 19) formed on the design film 42 according to the present embodiment is identical to the design print layer 43 formed on the touch panel film 40 of FIG. 4. The design print layer is not formed on the principal surface input region 10 (region almost all the range of the region 12 as a principal surface of the touch panel). The region is the transparent opening region 44 having light permeability. The design print layer was formed on an outer peripheral portion of the opening region 44.

For example, the guidance keys and the transparent background for various operations are formed at the portions (portions indicated by the dotted line) corresponding to the side surface input regions 15a and 15b by the design print layer 43. The non-light transmissive layer (design print layer 43) was printed on the region (lower right region of FIG. 19) that is the outer peripheral portion of the opening region 44 and that is not the side surface input region (see, FIG. 19). The touch panel terminal opening portion 16 is the opening at which the design print layer is not formed, the design print layer including the exposed touch panel terminals 18.

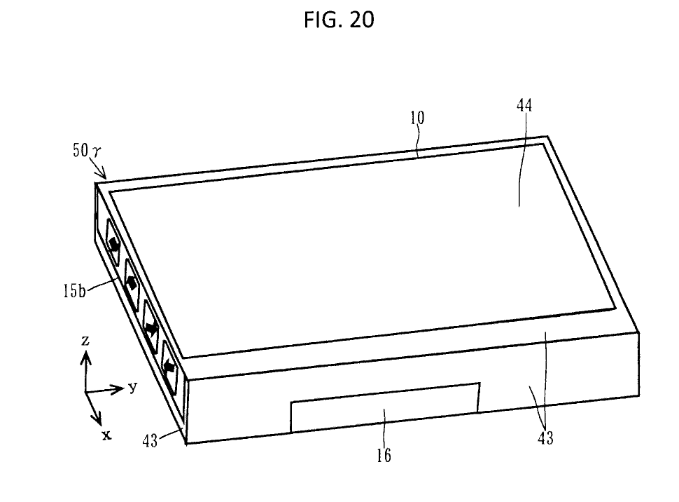

FIG. 20 is a perspective view of the design film heat forming body.

The design film heat forming body (γ) 50γ includes therein a rectangular-shaped hollow portion. The opening region 44 is formed on the principal surface of the design film 42. The opening region 44 is the transparent region having light permeability on which the design print layer 43 is not formed. The non-light transmissive design print layer 43 is formed on the outer peripheral portion of the opening region 44. The side surface input regions 15a and 15b are formed on the side surfaces. The outer peripheries of the side surface input regions 15a and 15b are enclosed by the design print layer 43. The touch panel terminal opening portion 16 is provided.

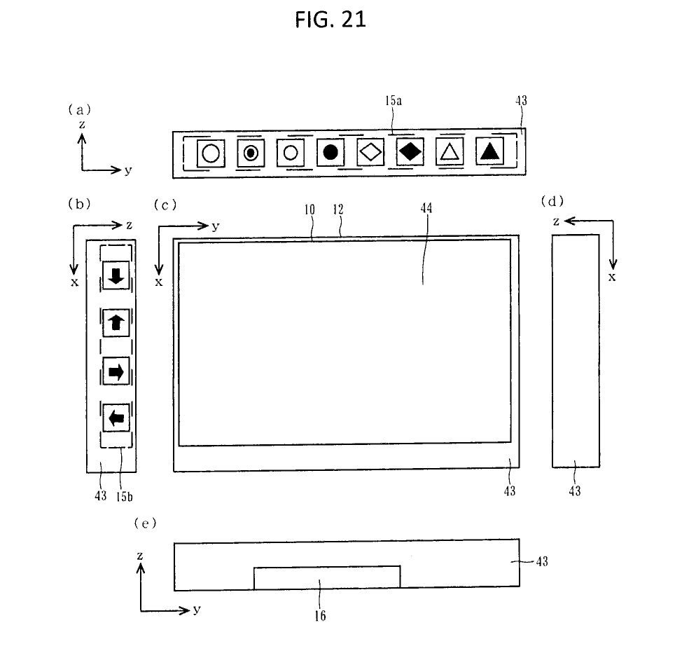

FIG. 21 includes illustrative drawings illustrating a design film heat forming body. FIG. 21(a) is a rear surface view thereof. FIG. 21(b) is a left-side surface view thereof. FIG. 21(c) is a plan view thereof. FIG. 21(d) is a right-side surface view thereof. FIG. 21(e) is a front surface view thereof.

The principal surface input region 10 is provided on the principal surface portion ((xy) surface) 12 of the design film heat forming body (γ) 50γ as the opening region 44. The principal surface input region 10 occupies almost all the range of the principal surface portion ((xy) surface) 12. The side surface input region 15a is provided on the rear surface (side surface) of the design film heat forming body (γ) 50γ. The side surface input region 15b is provided on the left side surface of the design film heat forming body (γ) 50γ. The touch panel terminal opening portion 16 and the design print layer 43 are provided on a front surface (side surface) of the design film heat forming body (γ) 50γ. The touch panel terminals 18 and the throughholes 19 are provided on/in the touch panel terminal opening portion 16. The design print layer 43 shields the lead wirings 22 and the lead wirings 32. The design print layer 43 that shields the lead wirings 32 is provided on the right side surface of the design film heat forming body (γ) 50γ (see, FIG. 21).

The bottom surface view of the design film heat forming body (γ) 50γ corresponds to the bottom surface view of the touch panel film heat forming body (α) of FIG. 8 (However, the touch panel film 40 is substituted by the design film 42. The island-shaped electrodes 20 and 30, the lead wirings 22 and 32, the throughholes 19, the touch panel terminals 18 (18a, 18b) are removed therefrom.). Therefore, a description thereof is omitted here.

<Input/Output Integrated Device (IV)>

An input/output integrated device (IV) (including the touch panel constituted of the touch panel molded body (d) and the display device) will be described below.

FIG. 22 includes illustrative drawings illustrating the input/output integrated device (IV). FIG. 22(a) is a cross sectional view thereof taken along the line X-X (a position similar to the position taken along the above described line X-X). FIG. 22(b) is a cross sectional view thereof taken along the line Y-Y (a position similar to the position taken along the above described line Y-Y).

The input/output integrated device (IV) 50IV of the present embodiment is similar to the input/output integrated device (I) 50I of FIG. 9. FIG. 22 is similar to FIG. 1 (However, the touch panel molded body (A) 50A is substituted by the touch panel molded body (D) 50D). Therefore, a description thereof will be omitted here.

<Process of Manufacturing Touch Panel Molded Bodies (A) to (D)>

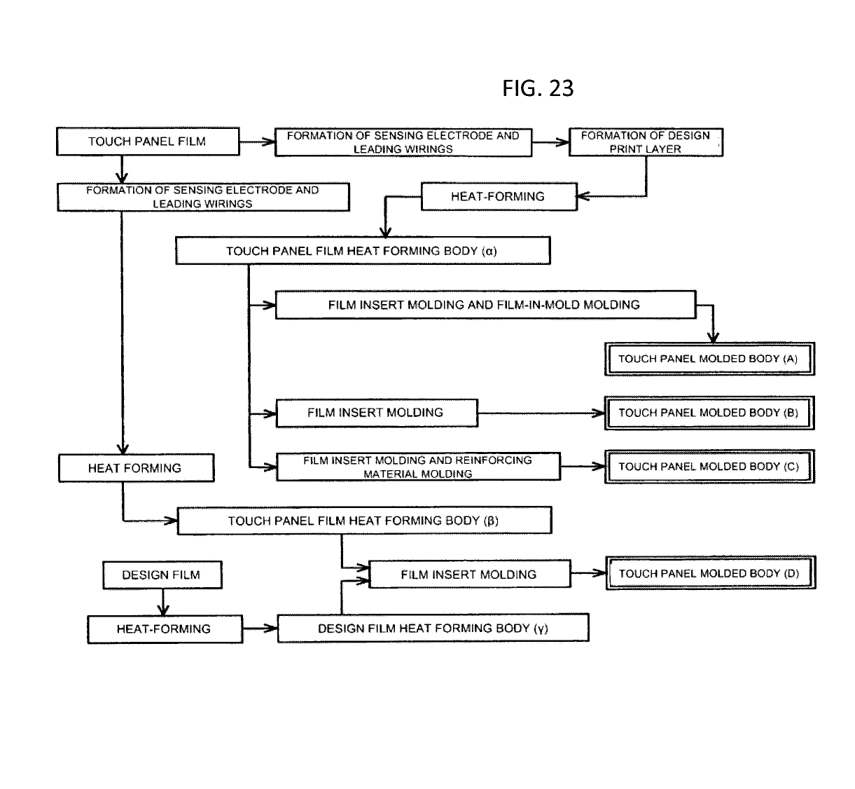

FIG. 23 is an illustrative drawing illustrating the process of manufacturing the touch panel molded bodies. Manufacturing processes of the touch panel molded bodies (A) to (D) are compared with one another for the sake of description.

In FIG. 23, the processes of manufacturing the touch panel molded bodies of FIG. 1 to FIG. 8, FIG. 11, FIG. 13, and FIG. 15 to FIG. 21 are comparatively illustrated. Initially, the island-shaped electrodes 20 and 30, the inter-electrode wirings 21 and 31, and the lead wirings 22 and 32 were formed on the touch panel film 40. Then, the design print layer 43 was formed thereon. Subsequently, the design print layer 43 was subjected to heat forming to be formed into the touch panel film heat forming body (α) 50α. The touch panel molded body (A) 50A was obtained by the film insert molding and the film-in-mold molding using the touch panel film heat forming body (α) 50α. The touch panel molded body (B) 50B was obtained by the film insert molding using the touch panel heat forming body (α) 50α. The touch panel molded body (C) 50C was obtained by the film insert molding and the reinforcing molding using the touch panel heat forming body (α) 50α.

The touch panel film 40 was provided with the island-shaped electrodes 20 and 30, the inter-electrode wirings 21 and 31, and the lead wirings 22 and 32 formed thereon. Then, the touch panel film heat forming body (β) 50β was manufactured by heat forming. The design print layer 43 was formed on the design film 42. Subsequently, the design film heat forming body (γ) 50γ was manufactured by heat forming. The touch panel molded body (D) 50D was manufactured by film insert molding using the touch panel film heat forming body (β) 50β and the design film heat forming body (γ) 50γ.

The input/output integrated device (I) 50I includes the touch panel molded body (A) 50A. The input/output integrated device (II) 50II includes the touch panel molded body (B) 50B. The input/output integrated device (III) 50III includes the touch panel molded body (C) 50C. The input/output integrated device (IV) 50IV includes the touch panel molded body (D) 50D.

<Exemplary Modification of Process of Manufacturing Touch Panel Molded Body>

Exemplary Modification of a process of manufacturing the touch panel molded body will be described below.

Below described is the exemplary modification of the process of manufacturing the touch panel molded body. The film insert process of the process of manufacturing the touch panel molded bodies (B), (C), and (D) was substituted by the film insert molding process and the film-in-mold molding process (similar to the process of manufacturing the touch panel molded body (A)). As a result, touch panel molded bodies (B′), (C′), and (D′) were obtained. The touch panel molded bodies (B′), (C′), and (D′) have such a configuration that the hard coat layer 45 is provided on the outermost layer of each of the touch panel molded bodies (B), (C), and (D).

The film-in-mold molding process was applied to the touch panel molded bodies (B), (C), and (D). As a result, the touch panel molded bodies (B′), (C′), and (D′) having such a configuration that the hard coat layer 45 is provided on the outermost layer of each of the touch panel molded bodies (B), (C), and (D) were obtained.

In the process of manufacturing the touch panel molded bodies (A) to (D), a preferable heating temperature of the resin film when the touch panel heat forming body (α), the touch panel heat forming body (β), and the design film heat forming body (γ) are formed is a softening temperature of the resin. The preferable softening temperature is equal to or less than 300°. Examples of such resin include PET (melting point: 258° C.), PEN (melting point: 269° C.), PE (melting point: 135° C.), PP (melting point: 163° C.), polystyrene (melting point: 230° C.), polyvinyl chloride (melting point: 180° C.), polyvinylidene chloride (melting point: 212° C.), and TAC (melting point: 290° C.).

In the process of manufacturing the touch panel molded bodies (A) to (D), the heating temperature for fluidizing the molded resin material (inject temperature of the molded resin material) is the melting temperature of the resin. For example, the melting point is about 240° C. in a case of acrylic resin, about 280° C. in a case of polyester resin, about 200° C. in a case of polyamide resin, and about 270° C. in cases of ABS resin, polystyrene resin, and polycarbonate resin.

<Exemplary Modification of Patterns for Island-Shaped Electrodes and Lead Wirings Formed on Touch Panel Film>

In the touch panel film (a) (see, FIG. 2) in which the net-shaped conductor (the island-shaped electrodes 20 and 30, the inter-electrode wirings 21 and 31, the lead wirings 22 and 32, and the touch panel terminals 18) patterns are formed on the touch panel film 40, the lead wirings 32 are formed on the right of the principal surface portion 12 (corresponding to one side surface ((xz) surface) perpendicular to the y-direction in the touch panel molded body). The lead wirings 22 and 32 and the touch panel terminals 18 are formed below (corresponding to one side surface ((yz) surface) perpendicular to the x-direction) the principal surface portion 12.

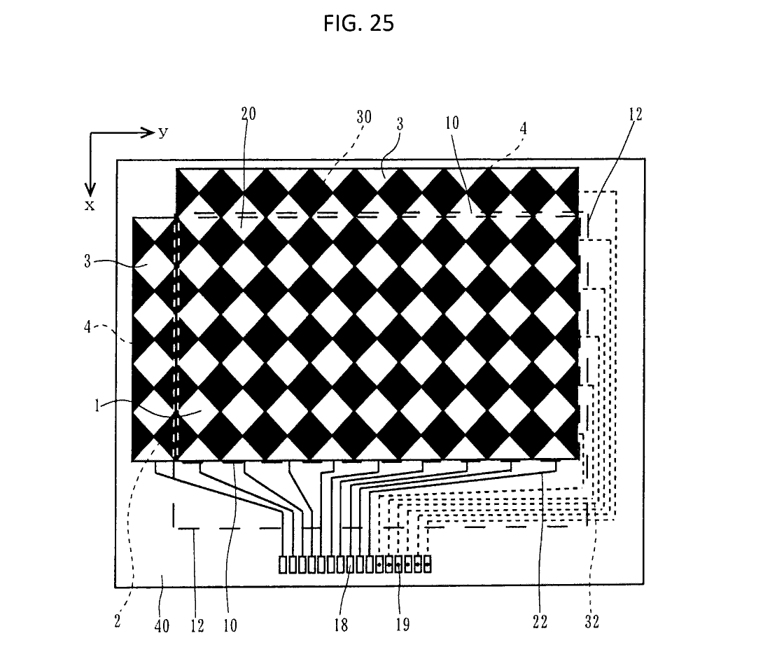

In the touch panel film (a) (see, FIG. 2), the touch panel film (b) (see, FIG. 24), and the touch panel film (c) (see, FIG. 25), the net-shaped conductor patterns of, for example, the island-shaped electrodes 20 and 30 are formed on the left (corresponding to the other side surface ((xz) surface) of the principal surface portion 12 perpendicular to the y-direction in the touch panel molded body and above (corresponding to the other side surface ((yz) surface) perpendicular to the x-direction in the touch panel molded body) the principal surface portion 12.

In the touch panel molded bodies (A) to (D) using the touch panel film (a), the touch panel terminals 18 to which the lead wirings 22 and the lead wirings 32 are connected are formed on one side surface ((yz) surface) perpendicular to the x-direction.

The lead wirings 22 pass through a crossing corner (ridgeline portion) at which two surfaces such as the principal surface ((xy) surface) and one side surface ((xz) surface) cross to each other. The lead wirings 22 and the lead wirings 32 pass through the crossing corner (ridgeline portion) at which two surfaces such as the principal surface ((xy) surface) and one side surface ((yz) surface) cross to each other. The lead wirings 32 pass through the crossing corner (ridgeline portion) at which two surfaces such as one side surface ((yz) surface) and one side surface ((xz) surface) cross to each other.

A touch panel film in which the net-shaped conductor patterns of, for example, the island-shaped electrodes 20 and 30 are formed on the touch panel film 40 is not limited to the touch panel film (a) of FIG. 2. The other examples thereof are illustrated in FIG. 24 to FIG. 28. With these net-shaped conductor patterns, the touch panel molded bodies are manufactured in a manner similar to the touch panel molded bodies (A) to (D).

FIG. 24 is a plan view of a touch panel film (b) on which the island-shaped electrodes and the lead wirings are formed.

In the touch panel film (b) in which the net-shaped conductor patterns are formed on the touch panel film 40, the lead wirings 32, the touch panel terminals 18, and the throughholes 19 are formed on/in the right (corresponding to one side surface ((xz) surface) perpendicular to the y-direction of the touch panel molded body) of the principal surface portion 12. The lead wirings 22 and the touch panel terminals 18 are formed below (corresponding to one side surface ((yz) surface) perpendicular to the x-direction of the touch panel molded body) the principal surface portion 12. The net-shaped conductor patterns of, for example, the island-shaped electrodes 20 and 30 are formed above (corresponding to one side surface ((yz) surface) perpendicular to the x-direction of the touch panel molded body) the principal surface portion 12 (see, FIG. 24). The electrode rows 1 are formed on the center position (the (xy) surface) of the front surface of the film. The electrode rows 2 are formed on the center position (the (xy) surface) of the rear surface of the film. The electrode rows 3 are formed on the left position (the (xz) surface) and the upper position (the (yz) surface) of the front surface of the film. The electrode rows 4 are formed on the left position (the (xz) surface) and the upper position (the (yz) surface) of the rear surface of the film.

In the touch panel molded bodies (A) to (D) using the touch panel film (b), the touch panel terminals 18 connected to the lead wirings 22 are formed on one side surface ((yz) surface). The touch panel terminals 18 connected to the lead wirings 32 are formed on one side surface ((xz) surface).

The lead wirings 22 pass through the crossing corner (ridgeline portion) between the principal surface ((xy) surface) and one side surface ((yz) surface). The lead wirings 32 pass through the crossing corner (ridgeline portion) between the principal surface ((xy) surface) and one side surface ((xz) surface).

FIG. 25 is a plan view of the touch panel film (c) on which the island-shaped electrodes and the lead wirings are formed.

In the touch panel film (c) on which the net-shaped conductor patterns are formed on the touch panel film 40, the lead wirings 32 are formed on the right (corresponding to one side surface ((xz) surface) perpendicular to the y-direction of the touch panel molded body) of the principal surface portion 12 and below (corresponding to one side surface ((yz) surface) of the touch panel molded body) the principal surface portion 12. The lead wirings 22 and the touch panel terminals 18 are formed below (corresponding to one side surface ((yz) surface) of the touch panel molded body) the principal surface portion 12. The lead wirings 22 and 32 are connected to the touch panel terminals 18 (see, FIG. 25).

In the touch panel film (c), the net-shaped conductor patterns of, for example, the island-shaped electrodes 20 and 30 are formed above (corresponding to one side surface ((yz) surface) of the touch panel molded body) the principal surface portion 12. The electrode rows 1, 2, 3, and 4 in FIG. 25 are formed correspondingly on positions almost identical to those of the electrode rows 1, 2, 3, and 4 in FIG. 24.

The lead wirings 22 pass through a crossing corner (ridgeline portion) between the principal surface ((xy) surface) and one side surface ((yz) surface). The lead wirings 32 pass through the crossing corner (ridgeline portion) between the principal surface ((xy) surface) and one side surface ((xz) surface). The lead wirings 32 pass through the crossing corner (ridgeline portion) between the side surface and the side surface.

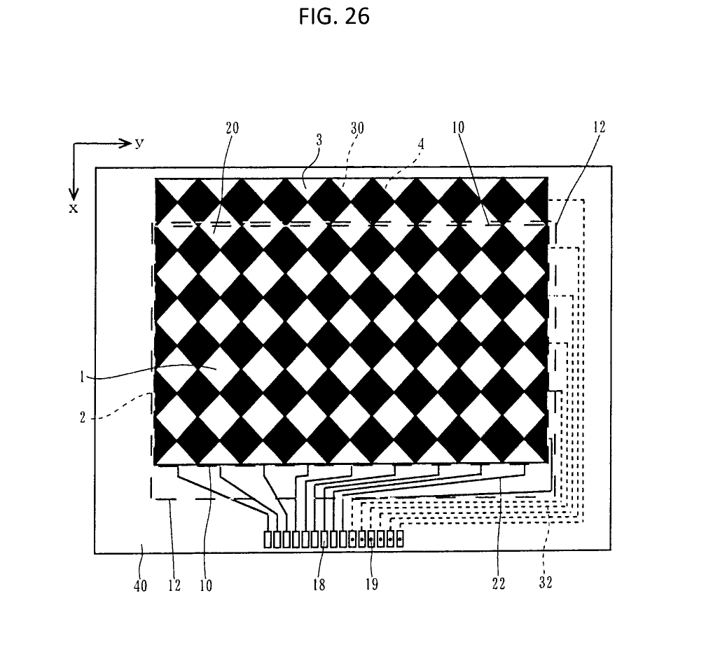

FIG. 26 is a plan view of a touch panel film (d) on which the island-shaped electrodes and the lead wirings are formed.

In the touch panel film (d) in which the net-shaped conductor patterns are formed on the touch panel film 40, the lead wirings 32 are formed on the right (corresponding to one side surface ((xz) surface) of the touch panel molded body) of the principal surface portion 12 and below (corresponding to one side surface ((yz) surface) of the touch panel molded body) the principal surface portion 12. The lead wirings 22 and the touch panel terminals 18 are formed below (corresponding to one side surface ((yz) surface) of the touch panel molded body) the principal surface portion 12. The lead wirings 22 and 32 are connected to the touch panel terminals 18 (see, FIG. 26).

In the touch panel film (d), the net-shaped conductor patterns of, for example, the island-shaped electrodes 20 and 30 are formed above (corresponding to one side surface ((yz) surface) of the touch panel molded body) the principal surface portion 12. Except that the electrode rows are not formed on the (xz) surface, the electrode rows 1, 2, 3, and 4 in FIG. 26 are formed correspondingly almost the same portions as the electrode rows 1, 2, 3, and 4 in FIG. 24.

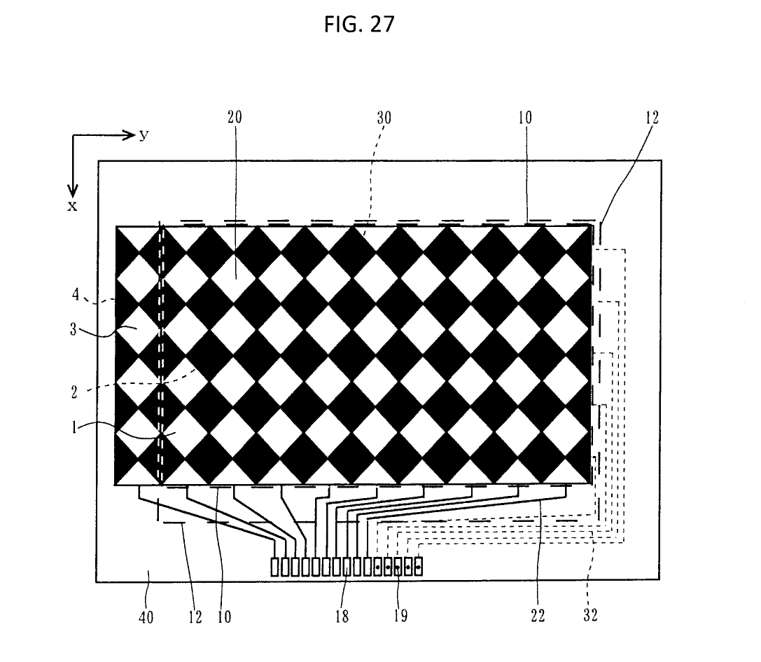

FIG. 27 is a plan view of a touch panel film (e) on which the island-shaped electrodes and the lead wirings are formed.

In the touch panel film (e) in which the net-shaped conductor patterns are formed on the touch panel film 40, the lead wirings 32 are formed on the right (corresponding to one side surface ((xz) surface) of the touch panel molded body) of the principal surface portion 12 and below (corresponding to one side surface ((yz) surface) of the touch panel molded body) the principal surface portion 12. The lead wirings 22 and the touch panel terminals 18 are formed below (corresponding to one side surface ((yz) surface) of the touch panel molded body) the principal surface portion 12. The lead wirings 22 and 32 are connected to the touch panel terminals 18 (see, FIG. 27).

In the touch panel film (e), the net-shaped conductor patterns of, for example, the island-shaped electrodes 20 and 30 are formed on the left (corresponding to one side surface ((xz) surface) of the touch panel molded body) of the principal surface portion 12. Except that the electrode rows are not formed on the (yz) surface, the electrode rows 1, 2, 3, and 4 in FIG. 27 are formed correspondingly on almost the same portions as the electrode rows 1, 2, 3, and 4 in FIG. 24.

The lead wirings 22 pass through the crossing corner (ridgeline portion) between the principal surface ((xy) surface) and one side surface ((yz) surface). The lead wirings 32 pass through the crossing corner (ridgeline portion) between the principal surface ((xy) surface) and one side surface ((xz) surface). The lead wirings 32 pass through the crossing corner (ridgeline portion) between the side surface and the side surface.

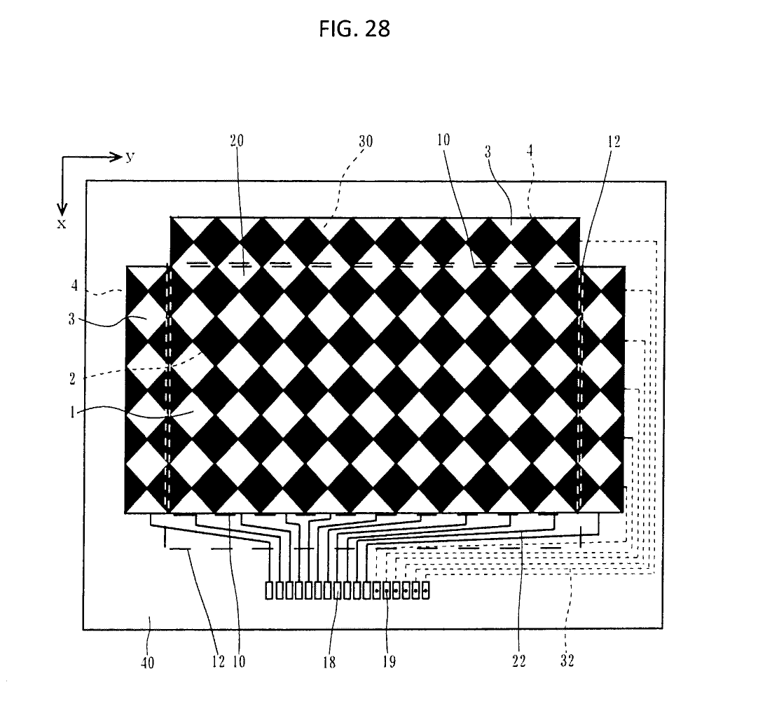

FIG. 28 is a plan view of a touch panel film (f) on which the island-shaped electrodes and the lead wirings are formed.

In the touch panel film (f) in which the net-shaped conductor patterns are formed on the touch panel film 40, the lead wirings 32 are formed on the right (corresponding to one side surface ((xz) surface) of the touch panel molded body) of the principal surface portion 12 and below (corresponding to one side surface ((yz) surface) of the touch panel molded body) the principal surface portion 12. The lead wirings 22 and the touch panel terminals 18 are formed below (corresponding to one side surface ((yz) surface) of the touch panel molded body) the principal surface portion 12. The lead wirings 22 and 32 are connected to the touch panel terminals 18 (see, FIG. 28).

In the touch panel film (f), the net-shaped conductor patterns of, for example, the island-shaped electrodes 20 and 30 are formed on the left (corresponding to one side surface ((xz) surface) of the touch panel molded body) of the principal surface portion 12, on the right (corresponding to the other side surface ((xz) surface) of the touch panel molded body) of the principal surface portion 12, and above (corresponding to one side surface ((yz) surface) of the touch panel molded body) the principal surface portion 12. Except that the electrode rows are also formed on the right side of the (xz) surface, the electrode rows 1, 2, 3, and 4 in FIG. 28 are formed correspondingly on almost the same portions as the electrode rows 1, 2, 3, and 4 in FIG. 24.

The lead wirings 22 pass through the crossing corner (ridgeline portion) between the principal surface ((xy) surface) and one side surface ((yz) surface). The lead wirings 32 pass through the crossing corner (ridgeline portion) between the principal surface ((xy) surface) and one side surface ((xz) surface). The lead wirings 22 and 32 pass through the crossing corner (ridgeline portion) between the side surface and the side surface.

One of the side surfaces perpendicular to the x-direction of the touch panel molded body and one of the side surfaces perpendicular to the y-direction of the touch panel molded body are provided with net-shaped conductor patterns (island-shaped electrodes 20 and 30, inter-electrode wirings 21 and 31), respectively. This achieves formation of side surface input regions. The regions of side surfaces that do not serve as the side surface input regions are provided with the lead wirings 22 and 32 formed thereon (see, FIG. 2, FIG. 24, and FIG. 25).

One of the side surfaces perpendicular to the x-direction (or y-direction) of the touch panel molded body is provided with the net-shaped conductor patterns (island-shaped electrodes 20 and 30, inter-electrode wirings 21 and 31) formed thereon. This achieves formation of the side surface input regions. The regions of the side surfaces that do not serve as the side surface input regions are provided with the lead wirings 22 and 32 (see, FIG. 26, and FIG. 27).

One of the side surfaces perpendicular to the x-direction of the touch panel molded body and two side surfaces perpendicular to the y-direction of the touch panel molded body are provided with the net-shaped conductor patterns (island-shaped electrodes 20 and 30, inter-electrode wirings 21 and 31), respectively. This achieves formation of the side surface input regions. The regions of the side surfaces that do not serve as the side surface input regions are provided with the lead wirings 22 and 32 formed thereon (see, FIG. 28).

The touch panel films illustrated in FIG. 2 and FIG. 24 to FIG. 28 are molded into a predetermined shape. This enables obtainment of the touch panel molded body. Since the net-shaped conductor patterns (island-shaped electrodes 20 and 30, inter-electrode wirings 21 and 31) are formed at the center portion of the touch panel film, the principal surface input region is formed thereon. The net-shaped conductor patterns are formed in the vicinity of the touch panel film, so that the side surface input region is formed. The touch panel molded body includes the side surface perpendicular to the principal surface of the touch panel molded body (e.g., a side surface selected from at least one of (i) the side surface serving as the side surface input region, (ii) the side surface on which the lead wirings 22 and 32 are formed, (iii) the surface that serves as the side surface input region and on which the lead wirings 22 and 32 are formed, and (iv) the side surface that does not serve as the side surface input region and on which no lead wirings 22 and 32 are formed). Therefore, it is not necessary to from the lead wirings 22 and 32 on the principal surface of the touch panel molded body. As a result, almost all the region of the principal surface portion 12 of the touch panel is allowed to serves as the principal surface input region. The frame region becomes as small as possible. Accordingly, the principal surface input region becomes as large as possible.

In the above description, shapes and dimensions of, for example, the island-shaped electrodes, the principal surface input region, the side surface input regions, and the touch panel molded bodies are mere exemplary descriptions. The present invention is not limited to the above embodiments. Various improvement, corrections, and modifications are covered by the present invention without departing from the technical concept of the present invention.

According to the present invention, a touch panel including input regions on a principal surface and side surfaces could be obtained. An input/output integrated device including the touch panel and a display device could be obtained. Such device has a good operability.

This application claims the benefit of Japanese Application No. 2012-201339, filed Sep. 13, 2012, the disclosure of which is hereby incorporated by reference.
1 first electrode rows
2 second electrode rows
3 third electrode rows
4 fourth electrode rows
10 principal surface input region
12 principal surface portion
15a, 15b side surface input region
16 touch panel terminal opening portion
18 touch panel terminals
18a terminals to which island-shaped electrodes arranged in an x-direction are connected
18b terminals to which island-shaped electrodes arranged in a y-direction are connected
19 throughholes
20 island-shaped electrodes arranged in the x-direction
21 inter-electrode wirings in the x-direction
22 lead wirings in the x-direction
23 isolated wirings on a forming surface of the lead wirings in the x-direction
30 island-shaped electrodes arranged in the y-direction
31 inter-electrode wirings in the y-direction
32 lead wirings in the y-direction
33 carbon
34 protective layers
40 touch panel film
42 design film
43 design print layer
44 opening region
45 hard coat layer
45a temporarily harden layer of a hard coat material
46 releasable film
50α touch panel film heat forming body (α)
50β touch panel film heat forming body (β)
50γ design film heat forming body (γ)
50A touch panel molded body (A)
50B touch panel molded body (B)
50C touch panel molded body (C)
50D touch panel molded body (D)
50I input/output integrated device (I)
50II input/output integrated device (II)
50III input/output integrated device (III)
50IV input/output integrated device (IV)
60 transparent resin
62 transparent resin case
63 hollow portion
67 upper side box body
69 lower side box body
70 flexible printed circuit board (FPC)
72 mount board with terminals
73 lead wirings covered with a protective layer
74 anisotropic conducting layer (AFC)
75 touch panel terminals covered with a protective layer
76 insulation layer
77 wiring conductor layer
78 FPC terminals
79 positions of throughholes
90 display device
91a, 93a, 95a, 95b, 97a projection-shaped mold
91b, 93b, 95c, 97b recess-shaped mold
92 mount board
96 reinforcing frame
100 touch panel control/signal processing circuit
110 display unit control/signal processing circuit
120 input/output integrated device control/signal processing circuit

1. An electrostatic capacitive touch panel comprising:
a case body made of an electrically insulating transparent resin film;
wherein the case body comprises a principal surface portion and side surface portions;
wherein the principal surface portion comprises a principal surface input region;
wherein at least one side surface portion comprises a side surface input region;
wherein the principal surface portion is provided with at least two first electrode rows and at least two second electrode rows;
wherein the at least two first electrode rows are arranged
at predetermined distances, and
in the first direction;
wherein the at least two second electrode rows are arranged
at predetermined distances, and
in the second direction;
wherein each of the first electrode rows and each of the second electrode rows comprise at least two island-shaped electrodes and inter-electrode wirings electrically connecting the island-shaped electrodes;
wherein the at least one side surface portion comprising the side surface input region is provided with one or more third electrode rows and one or more fourth electrode rows;
wherein the third electrode rows are arranged on an extension of the first electrode rows (and/or the second electrode rows);
wherein the fourth electrode rows are arranged in a direction of the second electrode rows (and/or the first electrode rows);
wherein ends of the first electrode rows or ends of the third electrode rows are electrically connected to one ends of first lead wirings;
wherein the other ends of the first lead wirings are formed on the side surface portion without comprising the side surface input region;
wherein ends of the second electrode rows and ends of the fourth electrode rows are electrically connected to one ends of second lead wirings;
wherein the other ends of the second lead wirings are formed on the side surface portion without comprising the side surface input region; and
wherein at least one of the first lead wirings and the second lead wirings pass through a ridgeline portion as a boundary between the neighboring side surface portions.

2. The electrostatic capacitive touch panel according to claim 1,
wherein the first electrode rows are provided on one surface side of the principal surface portion;
wherein the second electrode rows are provided on the other surface side of the principal surface portion;
wherein the third electrode rows are provided on a surface side where the electrode rows as origins of the third electrode rows are provided; and
wherein the fourth electrode rows are provided on a surface side where the electrode rows along with the fourth electrode rows are provided.

3. The electrostatic capacitive touch panel according to claim 1,
wherein the first electrode rows and the second electrode rows are provided on one surface side of the principal surface portion;
wherein electrically insulative spacers are provided between the first electrode rows and the second electrode rows at crossings between the first electrode rows and the second electrode rows;
wherein the third electrode rows and the fourth electrode rows are provided on one surface side of the side surface portion; and
wherein electrically insulative spacers are provided between the third electrode rows and the fourth electrode rows at crossings between the third electrode rows and the fourth electrode rows.

4. The electrostatic capacitive touch panel according to claim 1,
wherein the lead wirings passing through the ridgeline portion are arranged on an inner surface side of the case body.

5. The electrostatic capacitive touch panel according to claim 1,
wherein center positions of the island-shaped electrodes of the first electrode rows and center positions of the island-shaped electrodes of the second electrode rows are arranged so as to be differently positioned from one another when viewed from a direction orthogonal to the principal surface portion.

6. The electrostatic capacitive touch panel according to claim 1,
wherein the island-shaped electrodes of the first electrode rows and the island-shaped electrodes of the second electrode rows do not substantially overlap to one another when viewed from a direction orthogonal to the principal surface portion.

7. The electrostatic capacitive touch panel according to claim 1,
wherein a visible light shielding layer is provided on a region outside the principal surface input region of the principal surface portion and/or on a region outside the side surface input region of the side surface portion.

8. The electrostatic capacitive touch panel according to claim 1,
wherein a transparent resin layer is provided on a front surface of the case body.

9. The electrostatic capacitive touch panel according to claim 1,
wherein a hard coat layer is provided on the front surface of the case body.

10. The electrostatic capacitive touch panel according to claim 1,
wherein the transparent resin layer is provided on the front surface of the case body; and
wherein the hard coat layer is provided on a front surface of the transparent resin layer.

11. The electrostatic capacitive touch panel according to claim 1,
wherein a reinforcing frame is provided inside the side surface portions of the case body.

12. The electrostatic capacitive touch panel according to claim 1,
wherein the island-shaped electrodes in the principal surface input region are made of net-shaped conductors.

13. The electrostatic capacitive touch panel according to claim 1,
wherein the electrode rows in the principal surface input region are made of net-shaped conductors.

14. The electrostatic capacitive touch panel according to claim 12,
wherein the conductor is made of at least one metal selected from the group consisting of Ag, Au, Cu, and Al.

15. The electrostatic capacitive touch panel according to claim 1,
wherein external connection terminals are formed on the side surface portion without including the side surface input region;
wherein one of other ends of the first lead wirings and other ends of the second lead wirings are connected to the external connection terminals via throughholes; and
wherein the other one of the other ends of the first lead wirings and the other ends of the second lead wirings are connected to the external connection terminals without passing through the throughholes.

16. The electrostatic capacitive touch panel according to claim 15,
wherein front surfaces of the external connection terminals are covered with carbon.

17. A method for manufacturing an electrostatic capacitive touch panel, the electrostatic capacitive touch panel comprising
a case body made of an electrically insulating transparent resin film;
wherein the case body comprises a principal surface portion and side surface portions
wherein the principal surface portion comprises a principal surface input region;
wherein the at least one side surface portion comprises a side surface input region;
wherein the principal surface portion is provided with at least two first electrode rows and at least two second electrode rows;
wherein the at least two first electrode rows are arranged
at predetermined distances, and
in the first direction;
wherein the at least two second electrode rows are arranged
at predetermined distances, and
in the second direction;
wherein each of the first electrode rows and each of the second electrode rows comprise at least two island-shaped electrodes and inter-electrode wirings electrically connecting the island-shaped electrodes;
wherein the side surface portion comprising the side surface input region is provided with one or more third electrode rows and one or more fourth electrode rows;
wherein the third electrode rows are arranged on an extension of the first electrode rows (and/or the second electrode rows);
wherein the fourth electrode rows are provided in a direction of the second electrode rows (and/or the first electrode rows);
wherein ends of the first electrode rows or ends of the third electrode rows are electrically connected to one ends of first lead wirings;
wherein the other ends of the first lead wirings are formed on the side surface portion without comprising the side surface input region;
wherein ends of the second electrode rows and ends of the fourth electrode rows are electrically connected to one ends of second lead wirings;
wherein the other ends of the second lead wirings are formed on the side surface portion without comprising the side surface input region; and
wherein at least one of the first lead wirings and the second lead wirings pass through a ridgeline portion as a boundary between the neighboring side surface portions, the method for manufacturing the electrostatic capacitive touch panel comprising:
forming conductor patterns on the electrically insulating transparent resin film, the conductor patterns constituting the first electrode rows, the second electrode rows, the third electrode rows, the fourth electrode rows, the first lead wirings, and the second lead wirings; and
molding, after forming the conductor patterns, the electrically insulating transparent resin film into the case body.

18. The method for manufacturing the electrostatic capacitive touch panel according to claim 17,
wherein the first electrode rows are provided on one surface side of the principal surface portion;
wherein the second electrode rows are provided on the other surface side of the principal surface portion;
wherein the third electrode rows are provided on a surface side where the electrode rows as origins of the third electrode rows are provided; and
wherein the fourth electrode rows are provided on a surface side where the electrode rows along with the fourth electrode rows are provided.

19. The method for manufacturing the electrostatic capacitive touch panel according to claim 17:
wherein the first electrode rows and the second electrode rows are provided on one surface side of the principal surface portion;
wherein electrically insulative spacers are provided between the first electrode rows and the second electrode rows at crossings between the first electrode rows and the second electrode rows;
wherein the third electrode rows and the fourth electrode rows are provided on one surface side of the side surface portion; and
wherein electrically insulative spacers are provided between the third electrode rows and the fourth electrode rows at crossings between the third electrode rows and the fourth electrode rows.

20. The method for manufacturing the electrostatic capacitive touch panel according to claim 17,
wherein the lead wirings passing through the ridgeline portion are arranged on an inner surface side of the case body.

21. The method for manufacturing the electrostatic capacitive touch panel according to claim 17,
wherein center positions of the island-shaped electrodes of the first electrode rows and center positions of the island-shaped electrodes of the second electrode rows are arranged so as to be differently positioned from one another when viewed from a direction orthogonal to the principal surface portion.

22. The method for manufacturing the electrostatic capacitive touch panel according to claim 17,
wherein the island-shaped electrodes of the first electrode rows and the island-shaped electrodes of the second electrode rows are substantially not overlapped to one another when viewed from a direction orthogonal to the principal surface portion.

23. The method for manufacturing the electrostatic capacitive touch panel according to claim 17, further comprising:
providing, after forming the conductor patterns and before molding, a visible light shielding layer at a position corresponding to a region outside the principal surface input region of the principal surface portion and/or at a position corresponding to a region outside the side surface input region of the side surface portion.

24. The method for manufacturing the electrostatic capacitive touch panel according to claim 17, further comprising:
providing the transparent resin layer at a position corresponding to the front surface of the case body.

25. The method for manufacturing the electrostatic capacitive touch panel according to claim 17, further comprising:
providing the hard coat layer at a position corresponding to the front surface of the case body.

26. The method for manufacturing the electrostatic capacitive touch panel according to claim 17, further comprising:
providing a reinforcing frame inside the side surface portion of the case body.

27. The method for manufacturing the electrostatic capacitive touch panel according to claim 17,
wherein the island-shaped electrodes in the principal surface input region are made of net-shaped conductors.

28. The method for manufacturing the electrostatic capacitive touch panel according to claim 17,
wherein the electrode rows in the principal surface input region are made of net-shaped conductors.

29. A touch panel integrated display device comprising:
a display device; and
an electrostatic capacitive touch panel according to claim 1, the touch panel being disposed on a display of the display device.

30. The electrostatic capacitive touch panel according to claim 1,
the case body comprises a principal surface portion, side surface portions, and a hollow portion;
wherein the hollow portion is a region defined by the principal surface portion and the side surface portions;
wherein the side surface portions are
continuous to the principal surface portion, and
approximately orthogonal to the principal surface portion;
wherein there are at least four side surface portions approximately orthogonal to the principal surface portion;
wherein at least two side surface portions of the side surface portions are approximately orthogonal to a first direction in the principal surface portion;
wherein at least another two side surface portions of the side surface portions are approximately orthogonal to a second direction in the principal surface portion;
wherein at least one side surface portion of the at least four side surface portions comprises a side surface input region.

31. The method for manufacturing the electrostatic capacitive touch panel according to claim 17,
the case body comprises a principal surface portion, side surface portions, and a hollow portion;
wherein the hollow portion is a region defined by the principal surface portion and the side surface portions;
wherein the side surface portions are
continuous to the principal surface portion, and
approximately orthogonal to the principal surface portion;
wherein there are at least four side surface portions approximately orthogonal to the principal surface portion;
wherein at least two side surface portions of the side surface portions are approximately orthogonal to a first direction in the principal surface portion;
wherein at least another two side surface portions of the side surface portions are approximately orthogonal to a second direction in the principal surface portion;
wherein at least one side surface portion of the at least four side surface portions comprises a side surface input region.
